(19) United States
(12) Patent Application Publication
(10) Pub. No.: US 2026/0166449 A1
(43) Pub. Date: Jun. 18, 2026

(54) METHOD FOR DEMULSIFYING WATER-IN-OIL EMULSIONS

(71) Applicant: KING FAHD UNIVERSITY OF PETROLEUM AND MINERALS, Dhahran (SA)

(72) Inventors: Ghadeer Ghannam ALHARBI, Dhahran (SA); Theis SOLLING, Khobar (SA); Ahmed M. EL-ZOHRY, Dhahran (SA)

(73) Assignee: KING FAHD UNIVERSITY OF PETROLEUM AND MINERALS, Dhahran (SA)

(21) Appl. No.: 18/983,585

(22) Filed: Dec. 17, 2024

(51) Int. Cl. B01D 17/04

(52) U.S. Cl. CPC B01D 17/047; B01D 17/041

(57) ABSTRACT

A method of demulsifying a water-in-oil emulsion at room temperature including mixing an organic demulsifier solution comprising an organic solvent and about 200 ppm of a demulsifier relative to a total volume of the organic demulsifier solution with the water-in-oil emulsion to obtain an emulsion mixture, mixing an aqueous solution consisting of water and 0.005 to 2.5 wt. % of a chloride salt of a divalent zinc ion or a divalent calcium ion relative to a total volume of the aqueous solution with the water-in-oil emulsion to obtain a final emulsion, wherein the water-in-oil emulsion comprises 60 wt. % or more of water and 40 wt. % or less of an Arabian crude oil, agitating the final emulsion to obtain an agitated emulsion, and separating the agitated emulsion to form an oil phase and a water phase where the agitated emulsion achieves full phase separation in 7 minutes or less.

### BACKGROUND

### Technical Field

The present disclosure is directed to a method of demulsifying a water-in-oil emulsion, and particularly a method of demulsifying the water-in-oil emulsion at room temperature using a chloride salt of a divalent zinc ion or a divalent calcium ion.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly nor impliedly admitted as prior art against the present invention.

Crude oil extracted from geological formations often contains water, which enables the extracted crude oil to form stable water-in-oil emulsions that may hinder refining operations by inducing corrosion, reducing pipeline handling capacity, and increasing operating costs. The presence of water in the extracted crude oil may also lead to transportation challenges and equipment damage due to corrosion and fouling. Separating the oil and water phases in the extracted crude oil is important to achieve efficient processing and recovery in oil drilling operations. The separation process of extracted crude oil may often be challenging, however, due to the stability of the emulsion. The stability of these emulsions are determined by the crude oil's components and characteristics, such as the content of asphaltenes and resins in the crude oil, the viscosity, the pH, the drop diameter, and the temperature of the crude oil. Stable emulsions may result in prolonged separation times and reduced efficiency, posing a significant burden on oil refining practices.

To increase efficiency and decrease separation times in these practices, demulsifiers may be used. Numerous methods and compositions have been developed to enhance the demulsification performance of water-in-oil emulsions, with the most common method being the use of chemical demulsifiers. Demulsifiers work by destabilizing emulsions and promoting the coalescence of oil droplets for easier separation. Demulsifiers promote phase separation by weakening the interfacial film in the emulsion at the oil/water interface, resulting in a decrease of emulsion stability and separation of the water and oil phases. Chemical demulsifiers, however, pose significant issues such as their toxicity to the environment, their creation of secondary waste (i.e., sludge), and their ability to cause corrosion in refining equipment. Additionally, chemical demulsifiers can be very complex, with characteristics such as salinity, pH, temperature, the presence of naturally occurring surfactants, and viscosity of the crude oil emulsion affecting the efficiency of the chemical demulsifier. This may lead to some chemical demulsifiers only efficiently separating particular types crude oil emulsions and not others, which significantly limits their applicability across the oil industry. Therefore, new, cost-effective, and environmentally friendly methods of crude oil emulsion demulsification are needed to increase the efficiency of chemical demulsifiers among a broader range of oil types.

Accordingly, one object of the present disclosure is to provide a method of demulsifying a water-in-oil emulsion using bivalent cations as additives to improve the separation efficiency of the crude oil and water phases in crude oil emulsions.

### SUMMARY

In an exemplary embodiment, demulsifying a water-in-oil emulsion at room temperature is described. The method comprises mixing an organic demulsifier solution with the water-in-oil emulsion in an amount of about 200 parts per million (ppm), relative to a total volume of the organic demulsifier solution, to obtain an emulsion mixture. The method further comprises mixing an aqueous solution consisting of water and 0.005 to 2.5 wt. % of a chloride salt of a divalent zinc ion or divalent calcium ion with the water-in-oil emulsion, relative to a total weight of the aqueous solution, to obtain a final emulsion. The water-in-oil emulsion comprises 60 wt. % or more of water and 40 wt. % or less of an Arabian crude oil relative to a total weight of the water-in-oil emulsion.

The method further comprises agitating the final emulsion to obtain an agitated emulsion and separating the agitated emulsion to form an oil phase and a water phase. Finally, the agitated emulsion separates to form the water phase and the oil phase in less than 7 minutes.

In some embodiments, the water-in-oil emulsion comprises 70 wt. % or more of water relative to total weight of the water-in-oil emulsion.

In some embodiments, the water-in-oil emulsion comprises 30 wt. % or less of the Arabian crude oil relative to a total weight of the water-in-oil emulsion.

In some embodiments, the aqueous solution consists of water and 0.005 to 0.25 wt. % of the chloride salt of the divalent zinc ion or the divalent calcium ion relative to a total weight of the aqueous solution.

In some embodiments, the aqueous solution consists of water and 0.0125 to 0.25 wt. % of the chloride salt of the divalent zinc ion or the divalent calcium ion relative to a total weight of the aqueous solution.

In some embodiments, the aqueous solution consists of water and 0.0125 wt. % of the chloride salt of the divalent calcium ion relative to a total weight of the aqueous solution.

In some embodiments, the aqueous solution consists of water and 0.25 wt. % of the chloride salt of the divalent zinc ion relative to a total weight of the aqueous solution.

In some embodiments, the chloride salt of the divalent calcium ion is CaCl₂).

In some embodiments, the chloride salt of the divalent zinc ion is ZnCl₂.

In some embodiments, the Arabian crude oil has a density of 0.5 to 0.9 kilogram per cubic meter (kg·m⁻³).

In some embodiments, the Arabian crude oil has a density of 0.8843 kg·m⁻³.

In some embodiments, the organic demulsifier solution comprises at least one organic solvent selected from the group consisting of xylene, acetone, acetonitrile, ethanol, formaldehyde, ether, ethyl acetate, hexane, and toluene.

In some embodiments, the Arabian crude oil has a viscosity of 10 to 20 millipascal-second (mPa·s).

In some embodiments, the Arabian crude oil has a viscosity of 15.1 mPa·s.

In some embodiments, the Arabian crude oil comprises 30 to 35 wt. % of aromatics, 35 to 40 wt. % saturates, 10 to 15 wt. % of asphaltenes, and 15 to 20 wt. % of resins relative to a total weight of the Arabian crude oil.

In some embodiments, the Arabian crude oil comprises 33.15 wt. % of aromatics, 38.44 wt. % saturates, 12.10 wt. % of asphaltenes, and 16.32 wt. % of resins relative to a total weight of the Arabian crude oil.

In some embodiments, the final emulsion has a weight ratio of an amount of the emulsion mixture to an amount of the aqueous solution of 1:2 to 2:1.

In some embodiments, the final emulsion has a weight ratio of an amount of the emulsion mixture to an amount of the aqueous solution of 1:1.

In some embodiments, the agitated emulsion separates to form the water phase and the oil phase in less than 5 minutes (min).

In some embodiments, the agitated emulsion separates to form the water phase and the oil phase in less than 3 min.

The foregoing general description of the illustrative embodiments and the following detailed description thereof are merely exemplary aspects of the teachings of this disclosure and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1 is a schematic diagram of a method of demulsifying a water-in-oil emulsion at room temperature, according to certain embodiments.

FIG. 2A depicts the influence of different concentrations of CaCl₂) (500, 10,000, and 30,000 ppm) on the dehydration rate of five emulsions at time zero, compared to an emulsion prepared with deionized (DI) water only, in the presence of a demulsifier, according to certain embodiments.

FIG. 2B depicts the influence of different concentrations of CaCl₂) (500, 10,000, and 30,000 ppm) on the dehydration rate at time 1 min, compared to an emulsion prepared with DI water only, in the presence of a demulsifier, according to certain embodiments.

FIG. 2C depicts the influence of different concentrations of CaCl₂) (500, 10,000, and 30,000 ppm) on the dehydration rate at time 2 min, compared to an emulsion prepared with DI water only, in the presence of a demulsifier, according to certain embodiments.

FIG. 2D depicts the influence of different concentrations of CaCl₂) (500, 10,000, and 30,000 ppm) on the dehydration rate at time 3 min, compared to an emulsion prepared with DI water only, in the presence of a demulsifier, according to certain embodiments.

FIG. 2E depicts the influence of different concentrations of CaCl₂) (500, 10,000, and 30,000 ppm) on the dehydration rate at time 4 min, compared to an emulsion prepared with DI water only, in the presence of a demulsifier, according to certain embodiments.

FIG. 2F depicts the influence of different concentrations of CaCl₂) (500, 10,000, and 30,000 ppm) on the dehydration rate at time 5 min, compared to an emulsion prepared with DI water only, in the presence of a demulsifier, according to certain embodiments.

FIG. 2G depicts the influence of different concentrations of CaCl₂) (500, 10,000, and 30,000 ppm) on the dehydration rate at time 7 min, compared to an emulsion prepared with DI water only, in the presence of a demulsifier, according to certain embodiments.

FIG. 2H depicts the influence of different concentrations of CaCl₂) (500, 10,000, and 30,000 ppm) on the dehydration rate at time 8 min, compared to an emulsion prepared with DI water only, in the presence of a demulsifier, according to certain embodiments.

FIG. 2I depicts the influence of different concentrations of CaCl₂) (500, 10,000, and 30,000 ppm) on the dehydration rate at time 12 min, compared to an emulsion prepared with DI water only, in the presence of a demulsifier, according to certain embodiments.

FIG. 2J depicts the influence of different concentrations of CaCl₂) (500, 10,000, and 30,000 ppm) on the dehydration rate at time 14 min, compared to an emulsion prepared with DI water only, in the presence of a demulsifier, according to certain embodiments.

FIG. 2K depicts the influence of different concentrations of CaCl₂) (500, 10,000, and 30,000 ppm) on the dehydration rate at time 16 min, compared to an emulsion prepared with DI water only, in the presence of a demulsifier, according to certain embodiments.

FIG. 2L depicts the influence of different concentrations of CaCl₂ (500, 10,000, and 30,000 ppm) on the dehydration rate at time 18 min, compared to an emulsion prepared with DI water only, in the presence of a demulsifier, according to certain embodiments.

FIG. 2M depicts the influence of different concentrations of CaCl₂) (500, 10,000, and 30,000 ppm) on the dehydration rate at time 25 min, compared to an emulsion prepared with DI water only, in the presence of a demulsifier, according to certain embodiments.

FIG. 2N depicts the influence of different concentrations of CaCl₂) (500, 10,000, and 30,000 ppm) on the dehydration rate at time 40 min, compared to an emulsion prepared with DI water only, in the presence of a demulsifier, according to certain embodiments.

FIG. 2O depicts the influence of different concentrations of CaCl₂) (500, 10,000, and 30,000 ppm) on the dehydration rate at time 50 min, compared to an emulsion prepared with DI water only, in the presence of a demulsifier, according to certain embodiments.

FIG. 2P depicts the influence of different concentrations of CaCl₂) (500, 10,000, and 30,000 ppm) on the dehydration rate at time 4 hours (hrs), compared to an emulsion prepared with DI water only, in the presence of a demulsifier, according to certain embodiments.

FIG. 2Q shows a graph for the values extracted from FIGS. 2A through 2P regarding the influence of different concentrations of CaCl₂) (500, 10,000, and 30,000 ppm) on the dehydration rate of emulsions, according to certain embodiments.

FIG. 3A is an image illustrating the influence of different concentrations of CaCl₂ (200, 500, 10,000, and 30,000 ppm) on the dehydration rate at time zero, compared to an emulsion prepared with DI water only, in the presence of a demulsifier, according to certain embodiments.

FIG. 3B is an image illustrating the influence of different concentrations of CaCl₂ (200, 500, 10,000, and 30,000 ppm) on the dehydration rate at time 30 seconds (sec), compared to an emulsion prepared with DI water only, in the presence of a demulsifier, according to certain embodiments.

FIG. 3C is an image illustrating the influence of different concentrations of CaCl₂ (200, 500, 10,000, and 30,000 ppm) on the dehydration rate at time 45 sec, compared to an emulsion prepared with DI water only, in the presence of a demulsifier, according to certain embodiments.

FIG. 3D is an image illustrating the influence of different concentrations of CaCl₂ (200, 500, 10,000, and 30,000 ppm) on the dehydration rate at time 1 min, compared to an emulsion prepared with DI water only, in the presence of a demulsifier, according to certain embodiments.

FIG. 3E is an image illustrating the influence of different concentrations of CaCl₂ (200, 500, 10,000, and 30,000 ppm) on the dehydration rate at time 3 min, compared to an emulsion prepared with DI water only, in the presence of a demulsifier, according to certain embodiments.

FIG. 3F is an image illustrating the influence of different concentrations of CaCl₂ (200, 500, 10,000, and 30,000 ppm) on the dehydration rate of emulsions at time 5 min, compared to an emulsion prepared with DI water only, in the presence of a demulsifier, according to certain embodiments.

FIG. 3G is an image illustrating the influence of different concentrations of CaCl₂ (200, 500, 10,000, and 30,000 ppm) on the dehydration rate of emulsions at time 7 min, compared to an emulsion prepared with DI water only, in the presence of a demulsifier, according to certain embodiments.

FIG. 3H is an image illustrating the influence of different concentrations of CaCl₂ (200, 500, 10,000, and 30,000 ppm) on the dehydration rate of emulsions at time 10 min, compared to an emulsion prepared with DI water only, in the presence of a demulsifier, according to certain embodiments.

FIG. 3I is an image illustrating the influence of different concentrations of CaCl₂) (200, 500, 10,000, and 30,000 ppm) on the dehydration rate of emulsions at time 20 min, compared to an emulsion prepared with DI water only, in the presence of a demulsifier, according to certain embodiments.

FIG. 3J is an image illustrating the influence of different concentrations of CaCl₂ (200, 500, 10,000, and 30,000 ppm) on the dehydration rate of emulsions at time 25 min, compared to an emulsion prepared with DI water only, in the presence of a demulsifier, according to certain embodiments.

FIG. 3K is an image illustrating the influence of different concentrations of CaCl₂ (200, 500, 10,000, and 30,000 ppm) on the dehydration rate of emulsions at time 45 min, compared to an emulsion prepared with DI water only, in the presence of a demulsifier, according to certain embodiments.

FIG. 3L is an image illustrating the influence of different concentrations of CaCl₂ (200, 500, 10,000, and 30,000 ppm) on the dehydration rate of emulsions at time 1 hour, compared to an emulsion prepared with DI water only, in the presence of a demulsifier, according to certain embodiments.

FIG. 3M shows a graph regarding the influence of different concentrations of CaCl₂ (200, 500, 10,000, and 30,000 ppm) on the dehydration rate of emulsions, according to certain embodiments.

FIG. 4A depicts an image showing the influence of different concentrations of ZnCl₂ on the dehydration rate at time 0 for concentrations 200, 500, 10,000, and 30,000 ppm, compared to an emulsion prepared with DI water only, in the presence of a demulsifier, according to certain embodiments.

FIG. 4B depicts an image showing the influence of different concentrations of ZnCl₂ on the dehydration rate at time 1 min for concentrations 200, 500, 10,000, and 30,000 ppm, compared to an emulsion prepared with DI water only, in the presence of a demulsifier, according to certain embodiments.

FIG. 4C depicts an image showing the influence of different concentrations of ZnCl₂ on the dehydration rate at time 2 min for concentrations 200, 500, 10,000, and 30,000 ppm, compared to an emulsion prepared with DI water only, in the presence of a demulsifier, according to certain embodiments.

FIG. 4D depicts an image showing the influence of different concentrations of ZnCl₂ on the dehydration rate at time 4 min for concentrations 200, 500, 10,000, and 30,000 ppm, compared to an emulsion prepared with DI water only, in the presence of a demulsifier, according to certain embodiments.

FIG. 4E depicts an image showing the influence of different concentrations of ZnCl₂ on the dehydration rate at time 12 min for concentrations 200, 500, 10,000, and 30,000 ppm, compared to an emulsion prepared with DI water only, in the presence of a demulsifier, according to certain embodiments.

FIG. 4F depicts an image showing the influence of different concentrations of ZnCl₂ on the dehydration rate at time 30 min for concentrations 200, 500, 10,000, and 30,000 ppm, compared to an emulsion prepared with DI water only, in the presence of a demulsifier, according to certain embodiments.

FIG. 4G depicts an image showing the influence of different concentrations of ZnCl₂ on the dehydration rate at time 1 h for concentrations 200, 500, 10,000, and 30,000 ppm, compared to an emulsion prepared with DI water only, in the presence of a demulsifier, according to certain embodiments.

FIG. 4H depicts an image showing the influence of different concentrations of ZnCl₂ on the dehydration rate at time 2 h for concentrations 200, 500, 10,000, and 30,000 ppm, compared to an emulsion prepared with DI water only, in the presence of a demulsifier, according to certain embodiments.

FIG. 4I depicts an image showing the influence of different concentrations of ZnCl₂ on the dehydration rate at time 3.30 h for concentrations 200, 500, 10,000, and 30,000 ppm, compared to an emulsion prepared with DI water only, in the presence of a demulsifier, according to certain embodiments.

FIG. 4J depicts an image showing the influence of different concentrations of ZnCl₂ on the dehydration rate at time 4 h for concentrations 200, 500, 10,000, and 30,000 ppm, compared to an emulsion prepared with DI water only, in the presence of a demulsifier, according to certain embodiments.

FIG. 4K depicts an image showing the influence of different concentrations of ZnCl₂ on the dehydration rate at time 4.30 h for concentrations 200, 500, 10,000, and 30,000 ppm, compared to an emulsion prepared with DI water only, in the presence of a demulsifier, according to certain embodiments.

FIG. 4L depicts an image showing the influence of different concentrations of ZnCl₂ on the dehydration rate at time 5 h for concentrations 200, 500, 10,000, and 30,000 ppm, compared to an emulsion prepared with DI water only, in the presence of a demulsifier, according to certain embodiments.

FIG. 4M shows a graph regarding the influence of different concentrations of ZnCl₂ (200, 500, 10,000, and 30,000 ppm) on the dehydration rate of emulsions, according to certain embodiments.

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Embodiments of the present disclosure will now be described more fully hereinafter with reference to the accompanying drawings, in which some, but not all embodiments of the disclosure are shown.

As used herein, the words “about,” “approximately,” or “substantially similar” may be used when describing magnitude and or position to indicate that the value and/or position described is within a reasonable expected range of values and/or positions. For example, a numeric value may have a value that is +/−0.1% of the stated value (or range of values), +/−1% of the slated value (or range of values), +/−2% of the stated value (or range of values), +/−5% of the slated value (or range of values), +/−10% of the stated value (or range of values), +/−15% of the stated value (or range of values), or +/−20% of the stated value (or range of values). Within the description of this disclosure, where a numerical limit or range is stated, the endpoints are included unless stated otherwise. Also, all values and subranges within a numerical limit or range are specifically included as if explicitly written out.

As used herein, the term ‘emulsion’ refers to a heterogeneous mixture in which two immiscible liquids, typically oil and water, are combined, with one liquid dispersed as droplets within the other. This dispersion can be stabilized by emulsifying agents, such as surfactants, that reduce interfacial tension and prevent the coalescence of the dispersed droplets. Emulsions are commonly classified into two types: oil-in-water (O/W), where oil droplets are dispersed in water, and water-in-oil (W/O), where water droplets are dispersed in oil.

As used herein, the term ‘water-in-oil emulsion’ refers to a type of emulsion in which water droplets are dispersed within a continuous oil phase. This system is characterized by the water being the dispersed phase and the oil serving as the continuous phase.

As used herein, the term ‘aromatics’ or ‘aromatic compounds’ refers to a group of organic compounds, characterized by a ring structure with alternating single and double bonds, that are naturally present in crude oil, with common examples being benzene, toluene, xylenes, ethylbenzene, and naphthalene, which are cyclic, unsaturated hydrocarbons with a distinctive smell, and are considered valuable components for producing various petrochemical products like plastics and fuels; their concentration varies depending on the crude oil source

As used herein, the term ‘saturated hydrocarbons’ or ‘paraffins’ or ‘alkanes’ refers to compounds consisting of only single bonds between carbon atoms. The general formula for paraffins is CₙH₂ₙ₊₂, where ‘n’ is the number of carbon atoms. saturated hydrocarbons are characterized by their relatively inert nature, low reactivity, and high stability. Crude oil is primarily composed of a mixture of alkanes. Examples of saturated hydrocarbons include, but are not limited to, methane (CH₄), ethane (C₂H₆), propane (C₃H₈), and butane (C₄H₁₀).

As used herein, the term ‘asphaltenes’ refers to the complex, high-molecular-weight compounds found in crude oil and heavy petroleum products. They are characterized by their solubility in aromatic solvents (such as toluene) and insolubility in aliphatic solvents (such as pentane). Asphaltenes are primarily composed of carbon, hydrogen, nitrogen, oxygen, and sulfur, and they contribute to the viscosity, density, and stability of crude oil. Their molecular structure is polycyclic and can include heteroatoms, making them significantly more polar than other components of crude oil. Asphaltenes can cause problems during production and transportation of crude oil because they can make it more difficult and expensive to separate water from oil during processing.

As used herein, the term “full phase separation” or “complete separation” or “full dehydration” refers to when an emulsion's components separate into their individual parts (i.e., the water phase and the oil phase) such that no water remains dispersed in the oil phase as droplets.

As used herein, the term “partial phase separation” or “partial separation” or “partial dehydration” refers to when an emulsion's components separate into their individual parts (i.e., the water phase and the oil phase) such that a portion of the water phase remains dispersed in the oil phase as droplets.

As used herein, the term ‘resins’ refers to the complex organic compounds, made up of polar molecules and fused aromatic rings, present in crude oil and heavy petroleum fractions. They are characterized by their relatively high molecular weight and polar functional groups, which contribute to their solubility in aromatic solvents but insolubility in aliphatic solvents. Resins act as stabilizers for asphaltenes, helping to maintain their dispersion in crude oil.

Aspects of the present disclosure are directed to enhancing the demulsification of crude oil-water emulsions by utilizing bivalent cations, specifically calcium chloride (CaCl₂)) and zinc chloride (ZnCl₂), as additives. The addition of the cations at specific concentrations may enhance the separation of oil and water phases in emulsions at room temperature, providing a rapid and efficient phase separation where effective management of oil-water emulsions is needed.

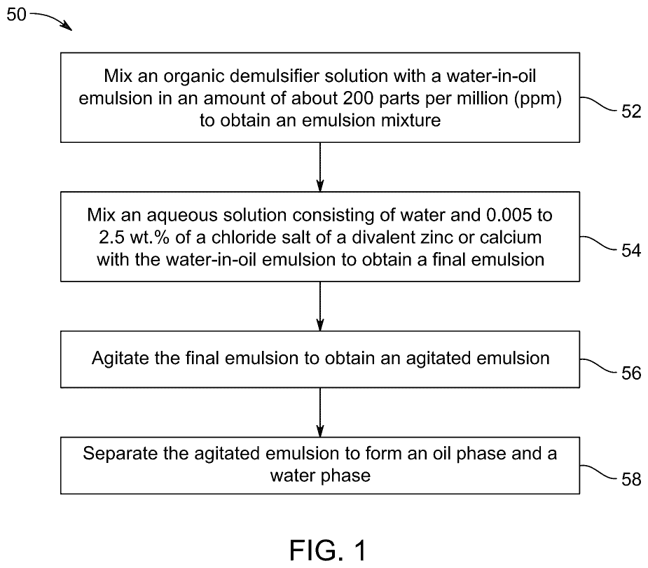

FIG. 1 illustrates a schematic flow chart of a method 50 of demulsifying a water-in-oil emulsion at room temperature. The order in which the method 50 is described is not intended to be construed as a limitation, and any number of the described method steps can be combined in any order to implement the method 50. Additionally, individual steps may be removed or skipped from the method 50 without departing from the spirit and scope of the present disclosure. Demulsification is the process of separating an emulsion into its individual components, typically by breaking the interfacial film that stabilizes the mixture. In a water-in-oil emulsion, the method involves removing the dispersed water droplets from the continuous oil phase, thus forming a water phase and an oil phase. In some embodiments, demulsification may be achieved by adding demulsifying agents, heating, centrifugation, pH changes, or changes in ionic strength. Demulsifiers may include, but are not limited to, nonylphenol ethoxylates, sorbitan esters, fatty alcohol ethoxylates, polyethylene glycol (PEG) derivatives, dodecylbenzene sulfonic acid, polymeric surfactants, alkyl polyglucosides, cationic surfactants, octyl phenol ethoxylates (e.g., Triton™ X series), polyvinyl alcohol (PVA) derivatives, ethoxylated alcohols, sodium dodecyl sulfate, lecithin, ammonium sulfate, sorbitan esters, polyacrylamide, nonylphenol ethoxylates, and dodecylbenzene sulfonic acid.

In some embodiment, at step 52, the method 50 comprises mixing an organic demulsifier solution with the water-in-oil emulsion in an amount of about 200 ppm, relative to a total weight of the organic demulsifier solution, to obtain an emulsion mixture. The organic demulsifier solution is a formulation containing organic compounds designed to destabilize and separate emulsions into their individual phases. In some embodiments, the organic demulsifier solution may include surfactants, solvents, and other additives that work together to reduce interfacial tension and promote the coalescence of dispersed droplets, thereby enhancing the efficiency of demulsification processes. Surfactants may aid in demulsification by adsorbing at the interface between the dispersed phase and the continuous phase in an emulsion, disrupting the stabilizing film that holds the droplets apart. By disrupting this stabilizing film, the surfactants cause the droplets coalesce and separate into distinct phases, enabling the water droplets to come together and form larger droplets that can readily separate out due to gravity. Solvents further aid the surfactant by acting as carriers for the demulsifier molecules, allowing them to effectively reach and interact with the interface between the dispersed phase and the continuous phase in an emulsion. The solvent aids the surfactant in the disruption of the stabilizing film and promoting the coalescence of droplets, promoting phase separation. Suitable carrier solvents may include, but are not limited to, xylene, heavy aromatic naphtha (HAN), acetonitrile, ether, ethyl acetate, hexane, toluene, isopropanol, methanol, and 2-ethylhexanol. Other additives that may be added in demulsifiers include, but are not limited to, ethylene oxides, propylene oxides, polyol block copolymers: A type of crude oil demulsifier base, alkoxylated alkyl phenol formaldehyde, epoxy resin alkoxylates, amine-initiated polyol block copolymers, modified silicone polyethers, and silicone polyethers. In some embodiments, the organic demulsifier solution comprises at least one organic solvent. In some embodiments, the organic solvent may include, but is not limited to, tetrahydrofuran, ethyl acetate, dimethylformamide, acetonitrile, acetone, dimethyl sulfoxide, nitromethane, propylene carbonate, ethanol, formic acid, n-butanol, methanol, or any combination thereof. In some embodiments, the organic solvent may include benzene, cyclohexane, ethanol, methanol, acetone, ethyl acetate, dichloromethane, toluene, and diethyl ether. In a preferred embodiment, the organic solvent is xylene. In some embodiments, mixing the organic demulsifier solution with the water-in-oil emulsion may be carried out manually or with the help of a stirrer. In some embodiments, mixing the organic demulsifier solution with the water-in-oil emulsion may be done by methods used or known in the art.

At step 54, the method 50 comprises mixing an aqueous solution consisting of water and 0.005 to 2.5 wt. % of a chloride salt of divalent zinc ion or divalent calcium ion, relative to a total weight of the final emulsion, with the water-in-oil emulsion to obtain a final emulsion. In some embodiments, the aqueous solution consists of water and 0.0075 to 2.25 wt. % of a chloride salt of a divalent zinc ion or divalent calcium ion, preferably 0.01 to 2 wt. %, preferably 0.0125 to 1.75 wt. %, preferably 0.0125 to 1.5 wt. %, preferably 0.0125 to 1.25 wt. %, preferably 0.0125 to 1 wt. %, preferably 0.0125 to 0.75 wt. %, preferably 0.0125 to 0.5 wt. %, most preferably 0.0125 to 0.25 wt. % of a chloride salt of a divalent zinc ion or divalent calcium ion. In some embodiments, the aqueous solution comprises water and 0.005 to 2.5 wt. % of a ZnCl₂, preferably 0.01 to 2.25 wt. %, preferably 0.02 to 2 wt. %, preferably 0.03 to 1.75 wt. %, preferably 0.04 to 1.5 wt. %, preferably 0.05 to 1.25 wt. %, preferably 0.06 to 1 wt. %, preferably 0.07 to 0.75 wt. %, preferably 0.08 to 0.5 wt. %, preferably 0.09 to 0.25 wt. %, preferably 0.1 to 0.25 wt. %, preferably 0.11 to 0.25 wt. %, preferably 0.12 to 0.25 wt. %, preferably 0.13 to 0.25 wt. %, preferably 0.14 to 0.25 wt. %, preferably 0.15 to 0.25 wt. %, preferably 0.16 to 0.25 wt. %, preferably 0.17 to 0.25 wt. %, preferably 0.18 to 0.25 wt. %, preferably 0.19 to 0.25 wt. %, preferably 0.2 to 0.25 wt. %, preferably 0.21 to 0.25 wt. %, preferably 0.22 to 0.25 wt. %, preferably 0.23 to 0.25 wt. %, most preferably 0.24 to 0.25 wt. % of ZnCl₂. In a preferred embodiment, the aqueous solution comprises water and 0.25 wt. % of ZnCl₂. In some embodiments, the aqueous solution comprises water and 0.005 to 2.5 wt. % of CaCl₂), preferably 0.01 to 2.25 wt. %, preferably 0.0125 to 2 wt. %, preferably 0.0125 to 1.75 wt. %, preferably 0.0125 to 1.5 wt. %, preferably 0.0125 to 1.25 wt. %, preferably 0.0125 to 1 wt. %, preferably 0.0125 to 0.75 wt. %, preferably 0.0125 to 0.5 wt. %, preferably 0.0125 to 0.25 wt. %, preferably 0.0125 to 0.2 wt. %, preferably 0.0125 to 0.15 wt. %, preferably 0.0125 to 0.1 wt. %, preferably 0.0125 to 0.05 wt. %, preferably 0.0125 to 0.04 wt. %, preferably 0.0125 to 0.03 wt. %, preferably 0.0125 to 0.02 wt. %, preferably 0.0125 to 0.0175 wt. %, most preferably 0.0125 to 0.015 wt. % of CaCl₂). In a preferred embodiment, the aqueous solution comprises water and 0.0125 wt. % of CaCl₂). The water in the aqueous solution is not particularly limited and may be tap water, distilled water, bi-distilled water, deionized water, deionized distilled water, and reverse osmosis water. In a preferred embodiment, the water is deionized water.

In some embodiments, the water-in-oil emulsion comprises 40 wt. % or more of water relative to a total weight of the water-in-oil emulsion, preferably 45 wt. % or more, preferably 50 wt. % or more, preferably 55 wt. % or more, preferably 60 wt. % or more, preferably 65 wt. % or more, most preferably 70 wt. % or more water. In some embodiments, the water-in-oil emulsion comprises 60 wt. % or less of Arabian crude oil relative to a total weight of the water-in-oil emulsion, preferably 55 wt. % or less, preferably 50 wt. % or less, preferably 45 wt. % or less, preferably 40 wt. % or less, preferably 35 wt. % or less, most preferably 30 wt. % or less of Arabian crude oil. In some embodiments, the Arabian crude oil comprises 25 to 40 wt. % aromatics relative to a total weight of the Arabian crude oil, preferably 21 to 39 wt. %, preferably 22 to 38 wt. %, preferably 23 to 37 wt. %, preferably 24 to 36 wt. %, preferably 25 to 35 wt. %, preferably 26 to 34 wt. %, preferably 27 to 34 wt. %, preferably 28 to 34 wt. %, preferably 29 to 34 wt. %, preferably 30 to 34 wt. %, preferably 31 to 34 wt. %, preferably 32 to 34 wt. %, preferably 33 to 34 wt. %, most preferably 33.15 wt. % of aromatics. In some embodiments, the Arabian crude oil comprises 30 to 45 wt. % of saturates relative to a total weight of the Arabian crude oil, preferably 31 to 44 wt. %, preferably 32 to 43 wt. %, preferably 33 to 42 wt. %, preferably 34 to 41 wt. %, preferably 35 to 40 wt. %, preferably 36 to 39 wt. %, preferably 37 to 39 wt. %, preferably 38 to 39 wt. %, most preferably 38.44 wt. % of saturates. In some embodiments, the Arabian crude oil comprises 5 to 20 wt. %, preferably 6 to 19 wt. %, preferably 7 to 18 wt. %, preferably 8 to 17 wt. %, preferably 9 to 16 wt. %, preferably 10 to 15 wt. %, preferably 11 to 14 wt. %, preferably 12 to 13 wt. %, most preferably 12.10 wt. % of asphaltenes. In some embodiments, the Arabian crude oil comprises 10 to 25 wt. % of resins, preferably 11 to 24 wt. %, preferably 12 to 23 wt. %, preferably 13 to 22 wt. %, preferably 14 to 21 wt. %, preferably 15 to 20 wt. %, preferably 16 to 19 wt. %, preferably 16 to 18 wt. %, preferably 16 to 17 wt. %, more preferably 16.32 wt. % of resins. In a specific embodiment, the Arabian crude oil comprises 33.15 wt. % of aromatics, 38.44 wt. % saturates, 12.10 wt. % of asphaltenes, and 16.32 wt. % of resins. The Arabian crude oil has a density of 0.5 to 0.9 kg·m⁻³, preferably 0.51 to 0.89 kg·m⁻³, preferably 0.52 to 0.89 kg·m⁻³, preferably 0.53 to 0.89 kg·m⁻³, preferably 0.54 to 0.89 kg·m⁻³, preferably 0.55 to 0.89 kg·m⁻³, preferably 0.56 to 0.89 kg·m⁻³, preferably 0.57 to 0.89 kg·m⁻³, preferably 0.58 to 0.89 kg·m⁻³, preferably 0.59 to 0.89 kg·m⁻³, preferably 0.60 to 0.89 kg·m⁻³, preferably 0.61 to 0.89 kg·m⁻³, preferably 0.62 to 0.89 kg·m⁻³, preferably 0.63 to 0.89 kg·m⁻³, preferably 0.64 to 0.89 kg·m⁻³, preferably 0.65 to 0.89 kg·m⁻³, preferably 0.66 to 0.89 kg·m⁻³, preferably 0.67 to 0.89 kg·m⁻³, preferably 0.68 to 0.89 kg·m⁻³, preferably 0.69 to 0.89 kg·m⁻³, preferably 0.70 to 0.89 kg·m⁻³, preferably 0.71 to 0.89 kg·m⁻³, preferably 0.72 to 0.89 kg·m⁻³, preferably 0.73 to 0.89 kg·m⁻³, preferably 0.74 to 0.89 kg·m⁻³, preferably 0.75 to 0.89 kg·m⁻³, preferably 0.76 to 0.89 kg·m⁻³, preferably 0.77 to 0.89 kg·m⁻³, preferably 0.78 to 0.89 kg·m⁻³, preferably 0.79 to 0.89 kg·m⁻³, preferably 0.80 to 0.89 kg·m⁻³, preferably 0.81 to 0.89 kg·m⁻³, preferably 0.82 to 0.89 kg·m⁻³, preferably 0.83 to 0.89 kg·m⁻³, preferably 0.84 to 0.89 kg·m⁻³, preferably 0.85 to 0.89 kg·m⁻³, preferably 0.86 to 0.89 kg·m⁻³, preferably 0.87 to 0.89 kg·m⁻³, preferably 0.88 to 0.89 kg·m⁻³, most preferably 0.8843 kg·m⁻³. The Arabian crude oil has a viscosity of 5 to 25 mPa·s, preferably 6 to 24 mPa·s, preferably 7 to 23 mPa·s, preferably 8 to 22 mPa·s, preferably 9 to 21 mPa·s, preferably 10 to 20 mPa·s, preferably 11 to 19 mPa·s, preferably 12 to 18 mPa·s, preferably 13 to 17 mPa·s, preferably 14 to 16 mPa·s, preferably 15 to 16 mPa·s, most preferably 15.1 mPa·s.

In some embodiment, at step 56, the method 50 comprises agitating the final emulsion to obtain an agitated emulsion. In some embodiments, the final emulsion may be subjected to a manual form of agitation such as stirring, swirling, shaking, and the like. In some embodiments, the final emulsion may be agitated by stirring equipment, such as a magnetic stirrer, an overhead stirrer, and the like, at a speed of 650 to 750 rotations per minute (rpm) for 5 to 25 min. In some embodiments, the final emulsion is stirred at a speed of 655 to 745 rpm, preferably 660 to 740 rpm, preferably 665 to 735 rpm, preferably 670 to 730 rpm, preferably 675 to 725 rpm, preferably 680 to 720 rpm, preferably 685 to 715 rpm, preferably 690 to 710 rpm, preferably 695 to 705 rpm, preferably 700 to 705 rpm, most preferably 700 rpm. In some embodiments, the final emulsion is stirred for 5 to 25 min, preferably 6 to 24 min, preferably 7 to 23 min, preferably 8 to 22 min, preferably 9 to 21 min, preferably 10 to 20 min, preferably 11 to 20 min, preferably 12 to 20 min, preferably 13 to 20 min, preferably 14 to 20 min, preferably 15 to 20 min, preferably 16 to 20 min, preferably 17 to 20 min, preferably 18 to 20 min, preferably 19 to 20 min, most preferably 20 min. In a preferred embodiment, the final emulsion is agitated using an overhead stirrer at 700 rpm for 20 minutes. The final emulsion has a weight ratio of the emulsion mixture to the aqueous solution of 1:5 to 5:1, preferably 1:4 to 4:1, preferably 1:3 to 3:1, preferably 1:2 to 2:1, most preferably 1:1 of the emulsion mixture to the aqueous solution.

In some embodiments, at step 58, the method 50 comprises separating the agitated emulsion to form an oil phase and a water phase. The agitated emulsion separates to form the water phase and the oil phase in 7 min or less, preferably 6.5 min or less, preferably 6 min or less, preferably 5.5 min or less, preferably 5 min or less, preferably 4.5 min or less, preferably 4 min or less, preferably 3.5 min or less, preferably 3 min or less, preferably 2.5 min or less, most preferably 2 min or less. Phase separation of an emulsion may be evaluated by calculating a dehydration efficiency of the emulsion, which calculates a percentage of water removed from the emulsion by comparing the initial water content to the water content after a dehydration process. A dehydration efficiency of less than 100% would be considered “partial separation” or “partial phase separation” such that a portion of the water phase remains disperse in the oil phase of the emulsion. A dehydration efficiency of 100% would be considered “full phase separation” or “complete separation” such that no water remains dispersed as droplets in the oil phase. The dehydration efficiency of a demulsifier may be evaluated as a function of time, such that a percentage of water is removed after a specific time period. In a preferred embodiment, the dehydration process utilized is the addition of a chemical demulsifier with a chloride salt of a divalent zinc ion and a divalent calcium ion. The water content (both initial and after dehydration) may be usually measured by weight or volume. In a preferred embodiment, the water content is measured by volume via calibrated cylindrical flasks and calibrated pipettes.

### EXAMPLES

The following examples demonstrate a method of demulsifying a water-in-oil emulsion. The examples are provided solely for illustration and are not to be construed as limitations of the present disclosure, as many variations thereof are possible without departing from the spirit and scope of the present disclosure.

### Example 1: Materials and Methods for CaCl₂) Testing

p-Xylene (99%) was purchased from Alfa Aesar and used as is. Calcium chloride (CaCl₂)) was purchased from Sigma Aldrich and used as is. Saudi Arabia's crude oil was obtained from Uthmania (Uth) reservoir. The SARA characterization of the crude is presented in Table 1. SX-100, a commercial demulsifier (CD), was used at 200 ppm concentrations. Deionized water (DI) obtained from the Milli-Q system was used in emulsion preparation.

TABLE 1
SARA analysis of the crude oil

| Density | API gravity | Viscosity | Content (wt. %) | | | |
|---|---|---|---|---|---|---|
| (kg m⁻³) | (—) | (mPa · s) | Aromatics | Saturates | Asphaltenes | Resins |
| 0.8843 | 28.20 | 15.1 | 33.15 | 38.44 | 12.10 | 16.32 |

To prepare the water-in-oil emulsion, the crude oil was transferred to a 50 ml beaker and the aqueous phase was added dropwise in a 60:40 (water to oil ratio). The water-in-oil emulsion was then mixed using an overhead stirrer at 700 rpm for 20 min. The incorporation of the CaCl₂) solution into the water-in-oil emulsion to obtain the emulsion mixture was performed by two separate methods, either by (1) incorporating the CaCl₂) within the water-in-oil emulsion by mixing the crude oil with a CaCl₂) solution at different CaCl₂) concentrations or (2) adding the CaCl₂) solution as an external additive. The prepared emulsion mixtures were then placed in bottles. Each bottle prepared by the first method of CaCl₂) incorporation (mixing CaCl₂) solution in the crude oil) contains 4 mL of the lab-made water-in-oil emulsion (60 wt. % DI water or brine, 40 wt. % crude oil), 4 mL of 0.02 wt. % demulsifier dissolved in xylene, and CaCl₂) at various concentrations. The concentrations of CaCl₂) tested are 0 ppm CaCl₂) solution (DI only), 200 ppm, CaCl₂) solution (0.02 wt. %) (Ca200), 500 ppm CaCl₂) solution (0.05 wt. %) (Ca500), 10,000 ppm CaCl₂) solution (1 wt. %) (Ca10,000), 30,000 ppm CaCl₂) solution (3 wt. %) (Ca30,000). A blank was also prepared and bottled, which contains 4 mL of the lab-made water-in-oil emulsion and 4 mL demulsifier in xylene (demulsifier only, no CaCl₂)). Each bottle prepared by the second method of CaCl₂) incorporation (adding CaCl₂) as external additive) contains 3 mL of lab-made water-in-oil emulsion (60 wt. % DI water, 40 wt. % crude oil), 3 mL of 0.02 wt. % demulsifier dissolved in xylene, and 3 mL of brine with various CaCl₂) concentrations. A blank was also prepared and bottled, which contains 3 mL of the lab-made water-in-oil emulsion, 3 mL of demulsifier in xylene, and 3 mL DI water (no CaCl₂)).

### Example 2: Demulsification Test of Prepared Emulsion Mixtures with CaCl₂)

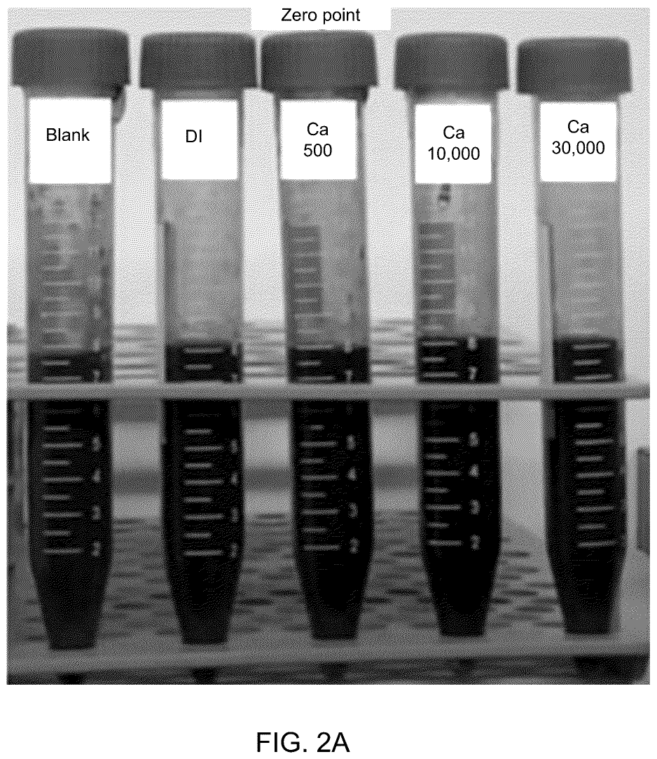

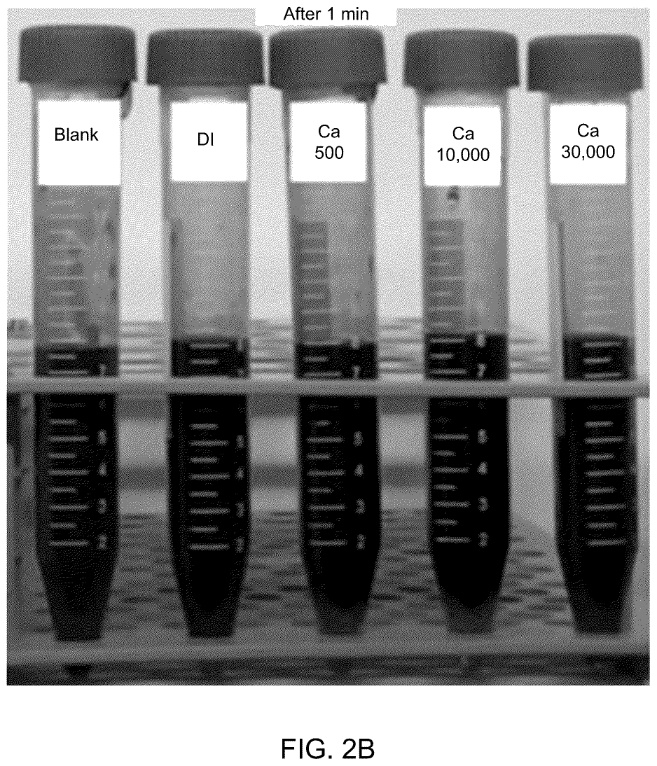

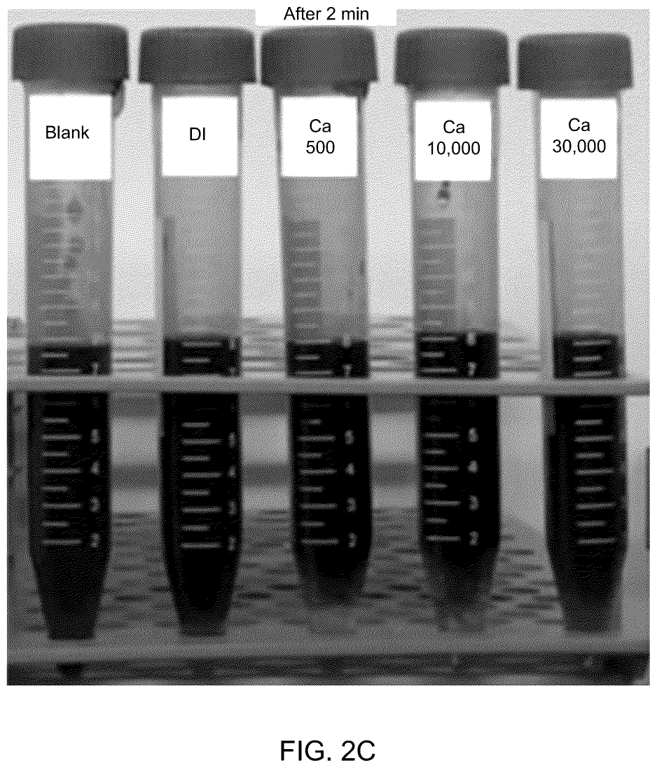

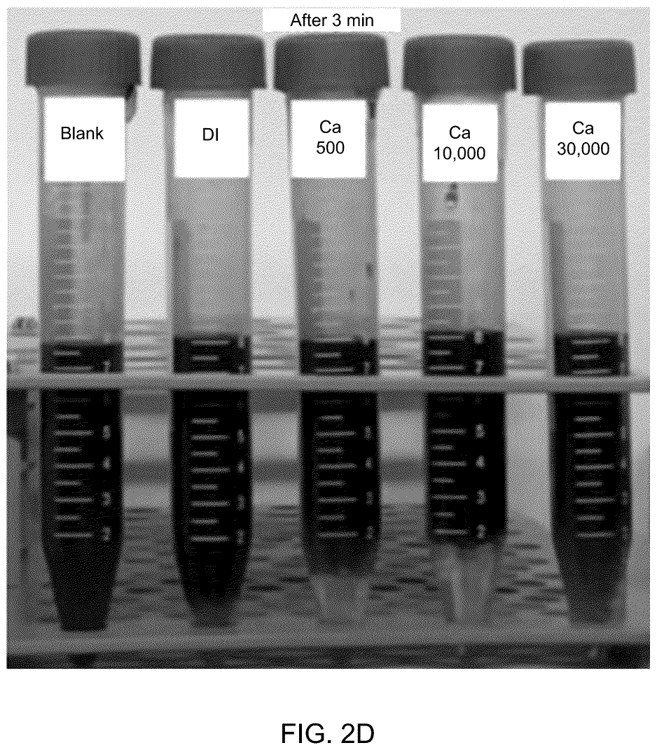

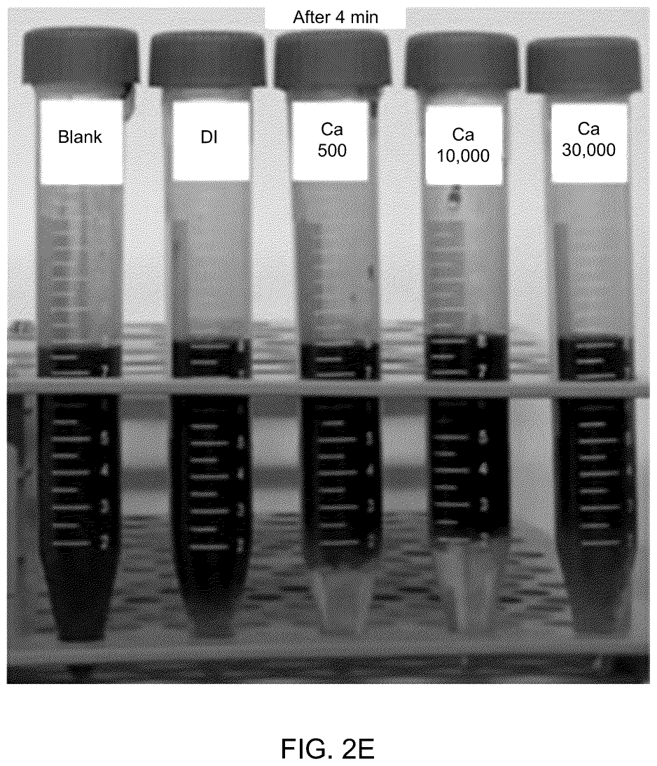

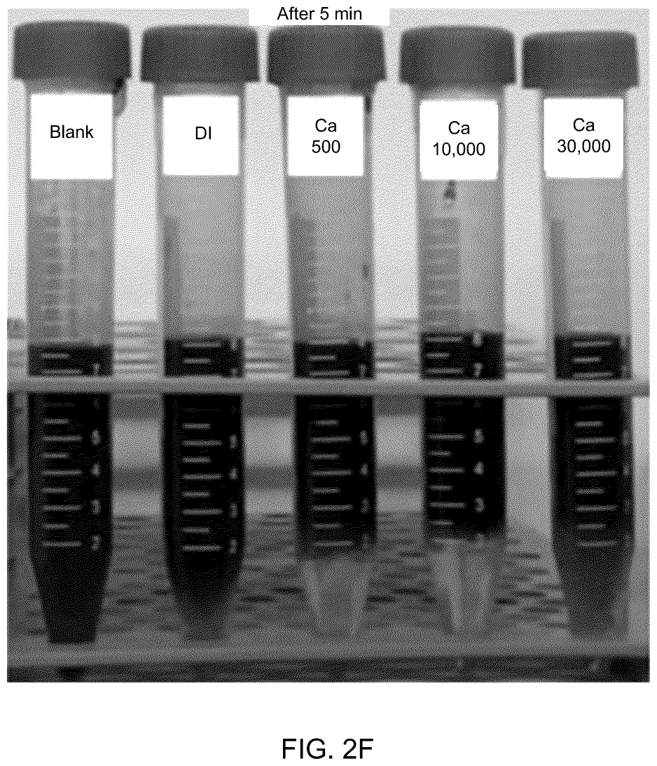

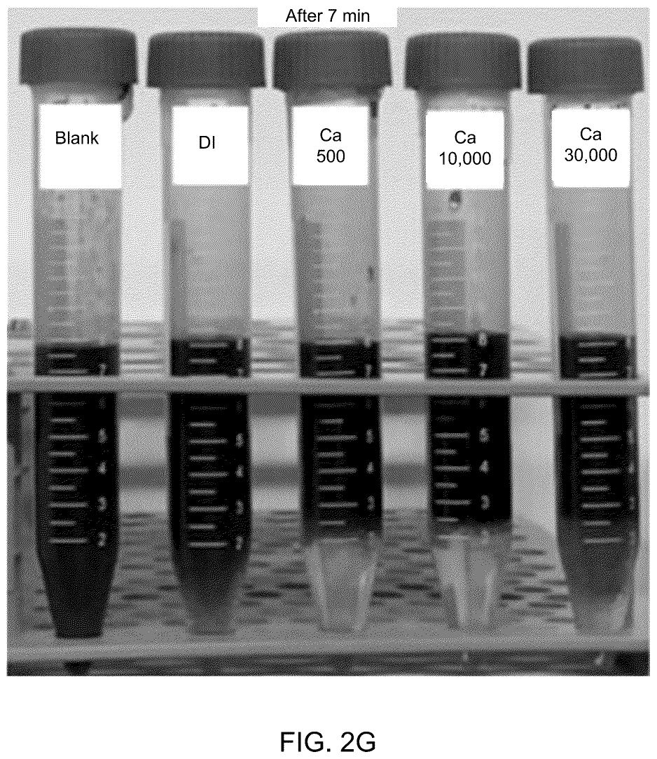

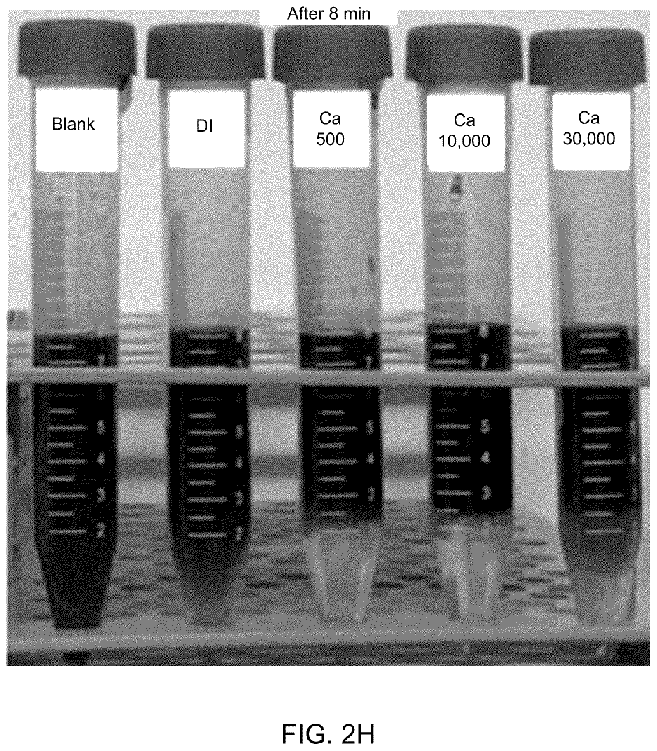

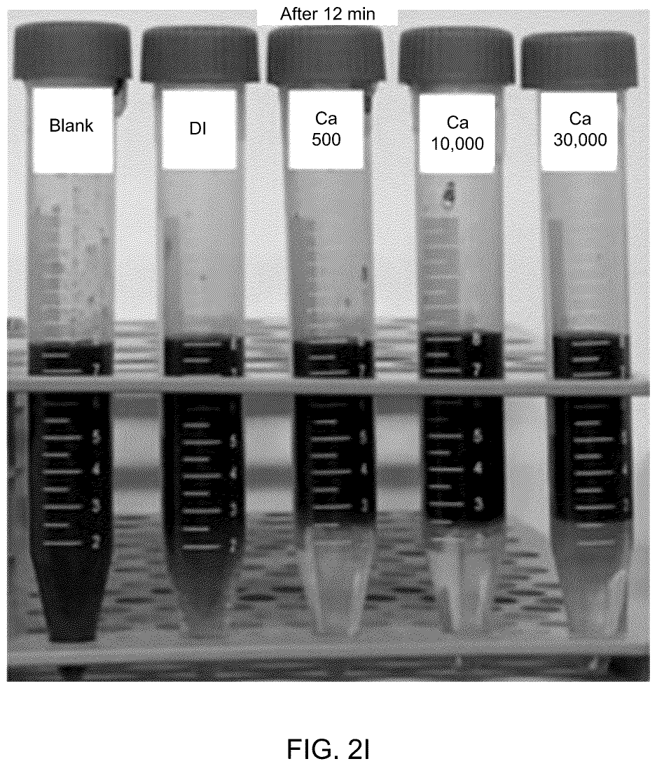

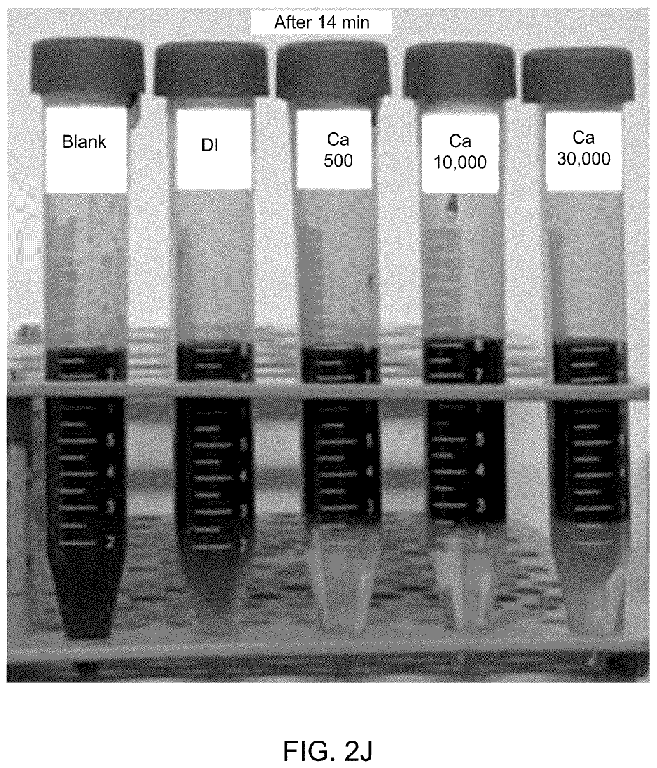

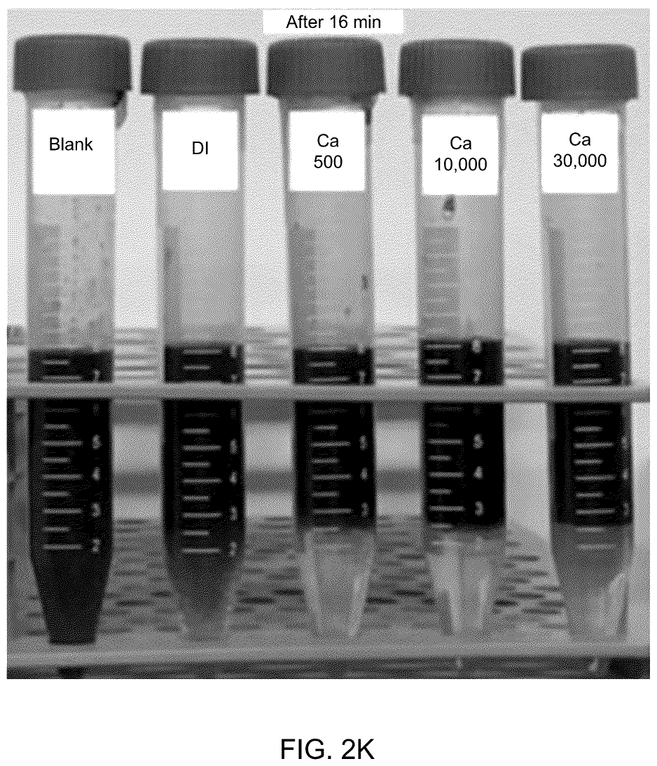

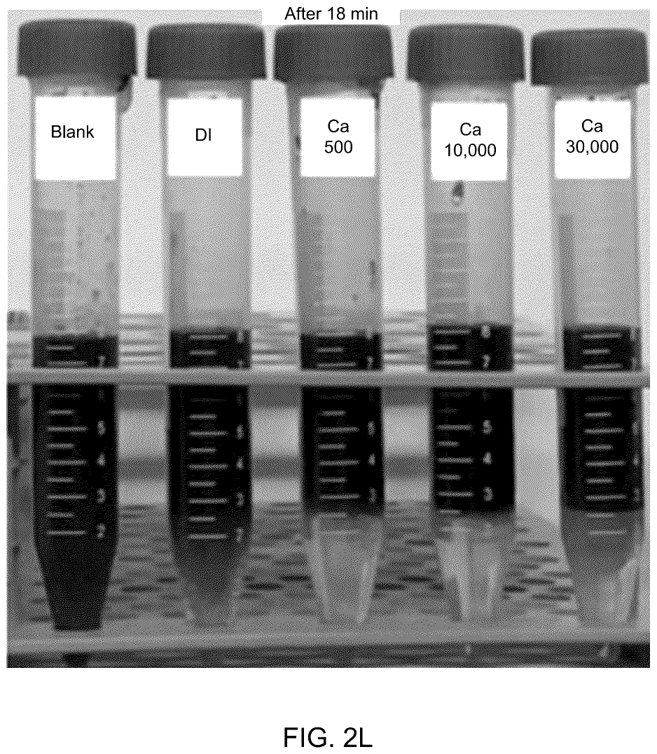

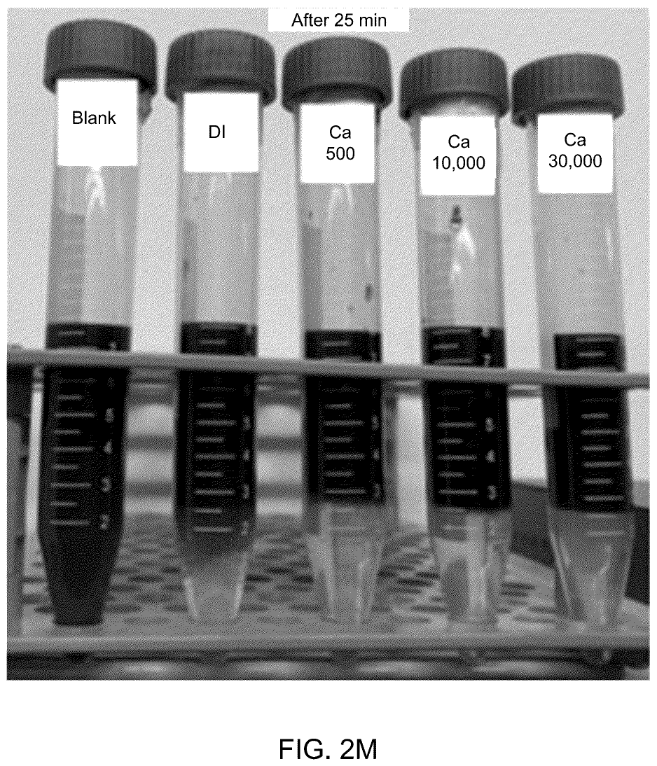

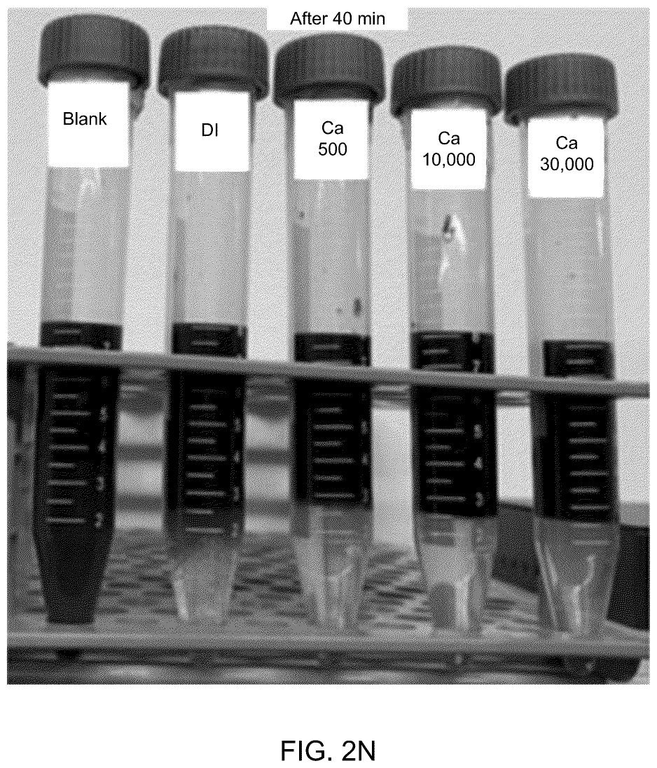

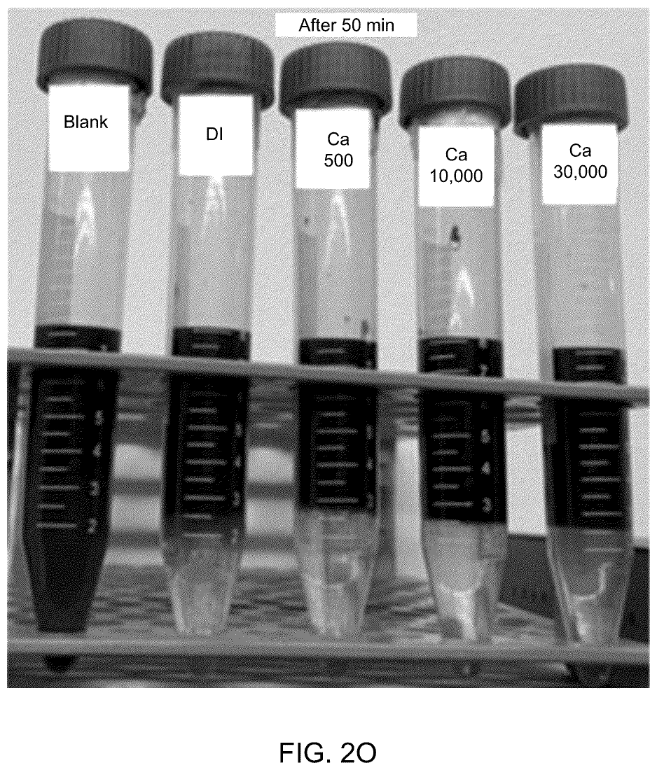

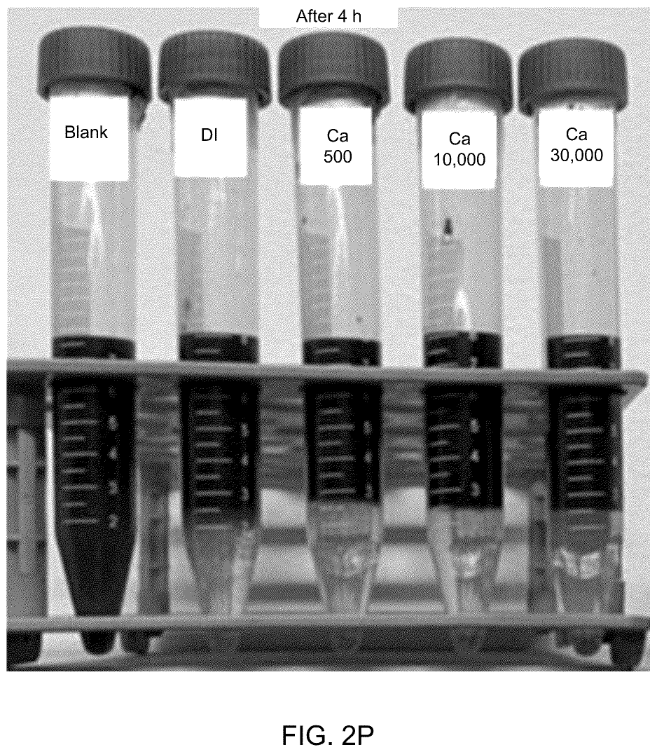

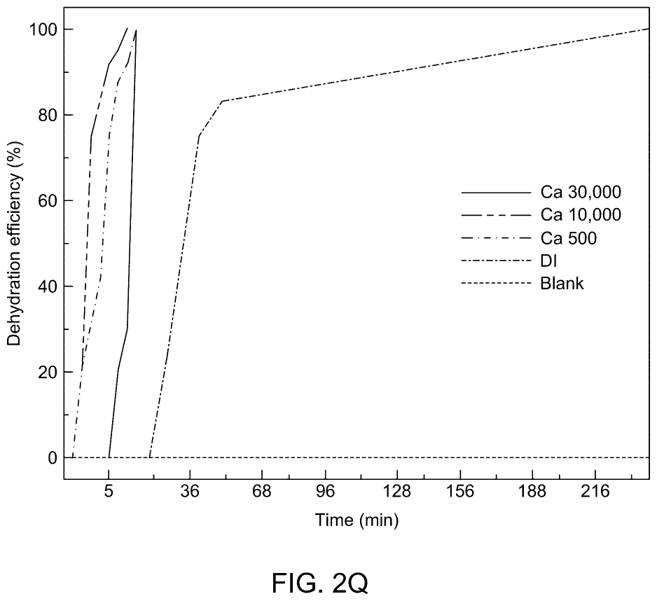

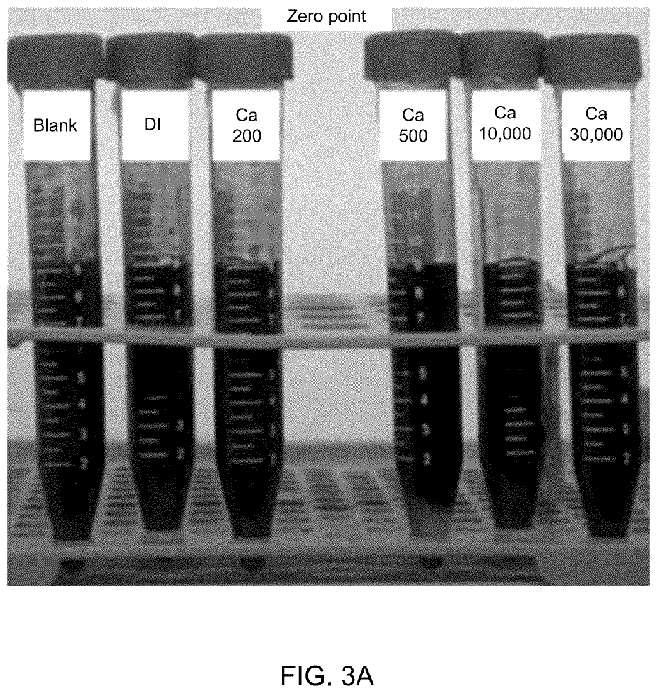

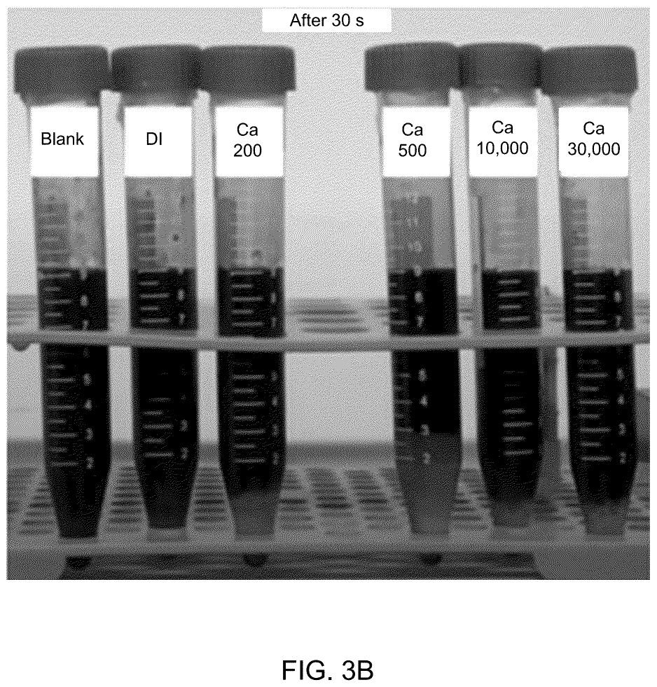

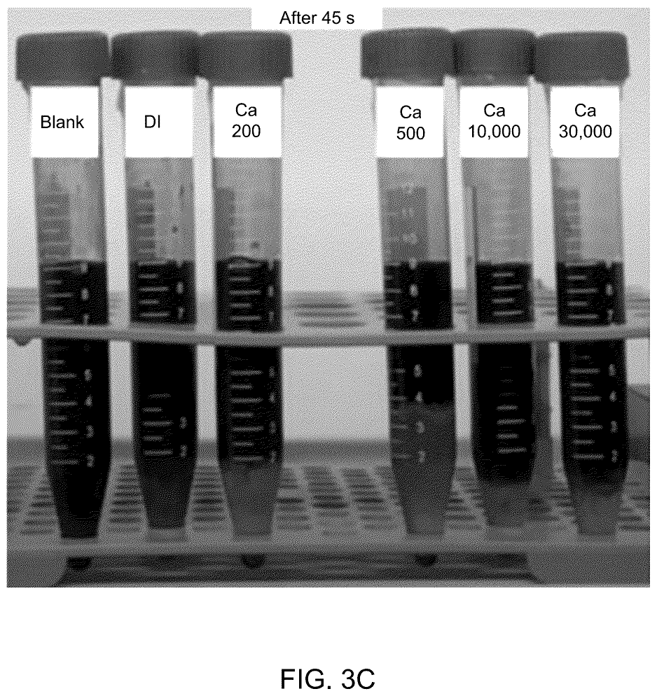

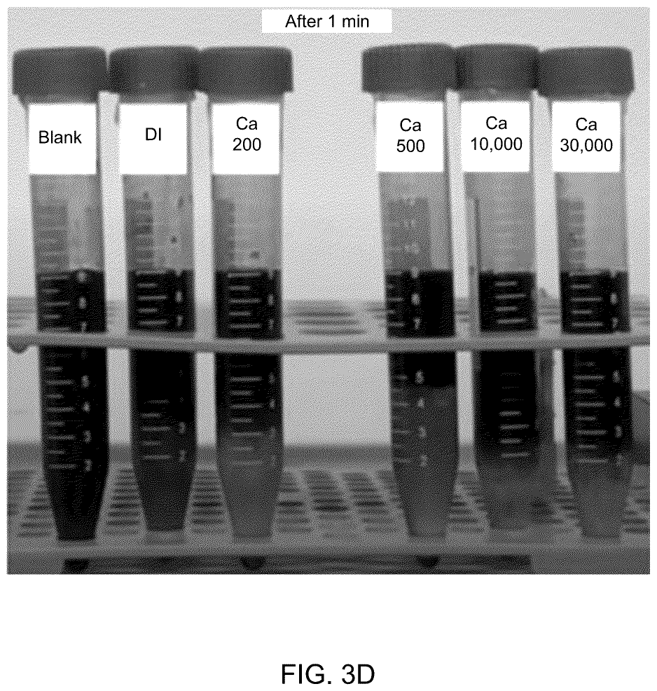

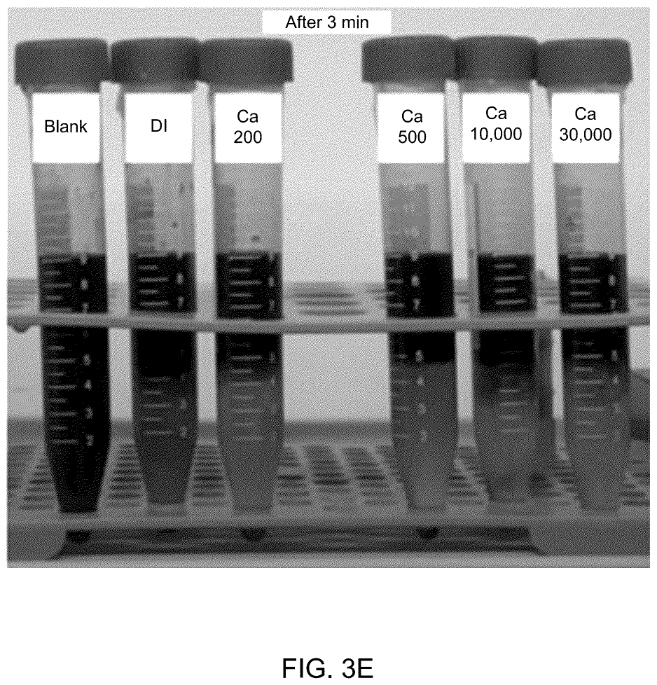

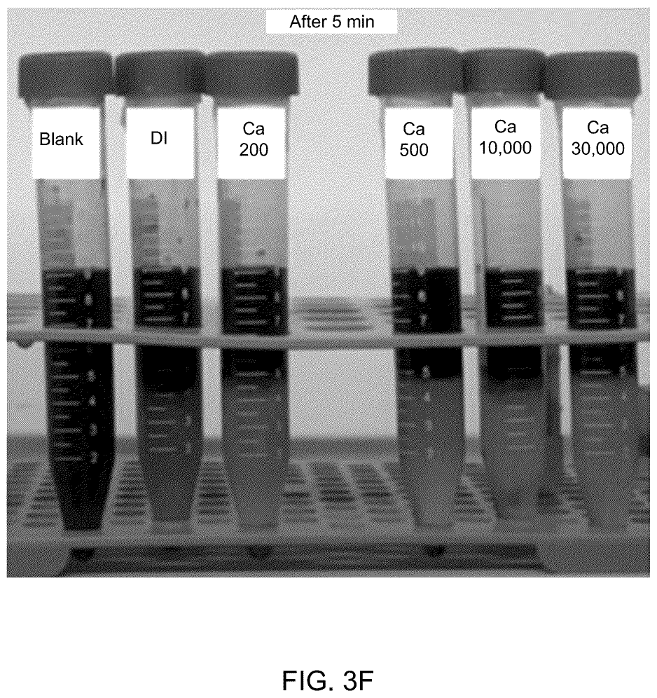

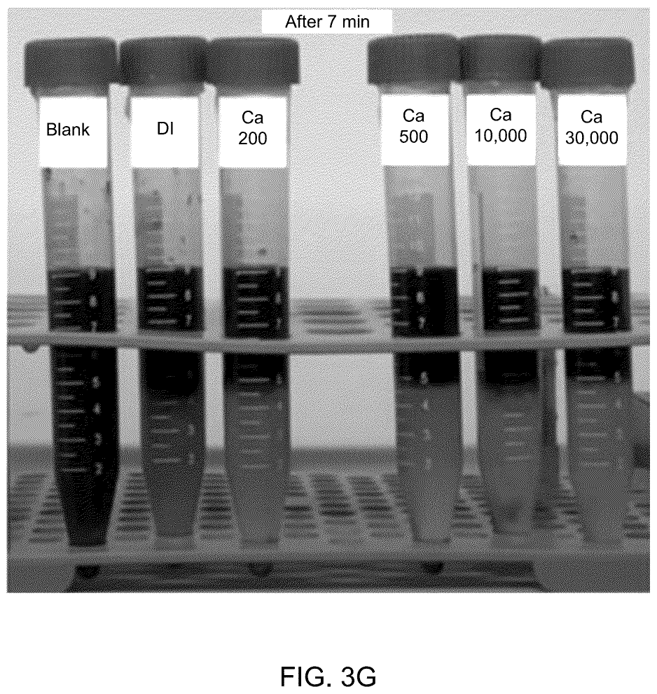

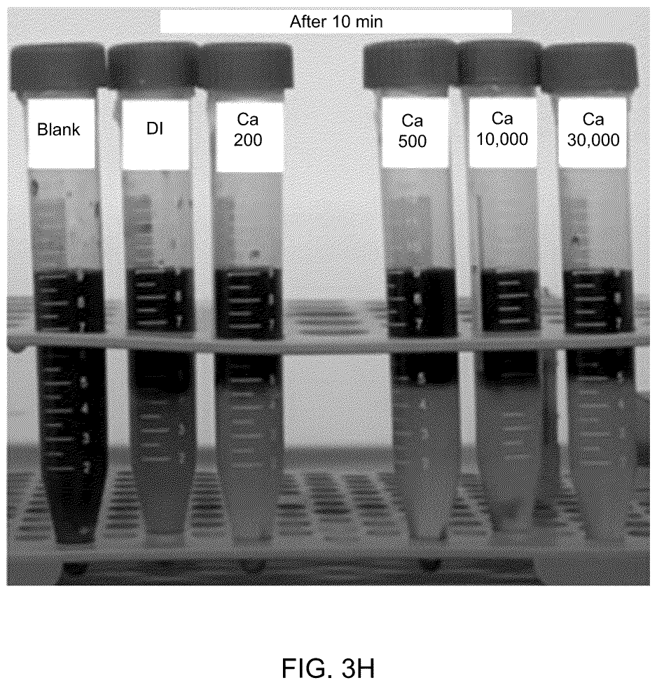

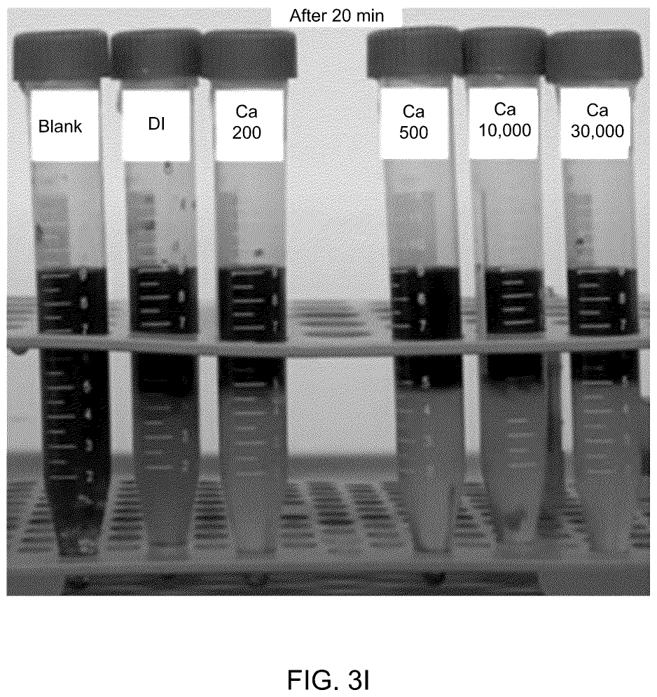

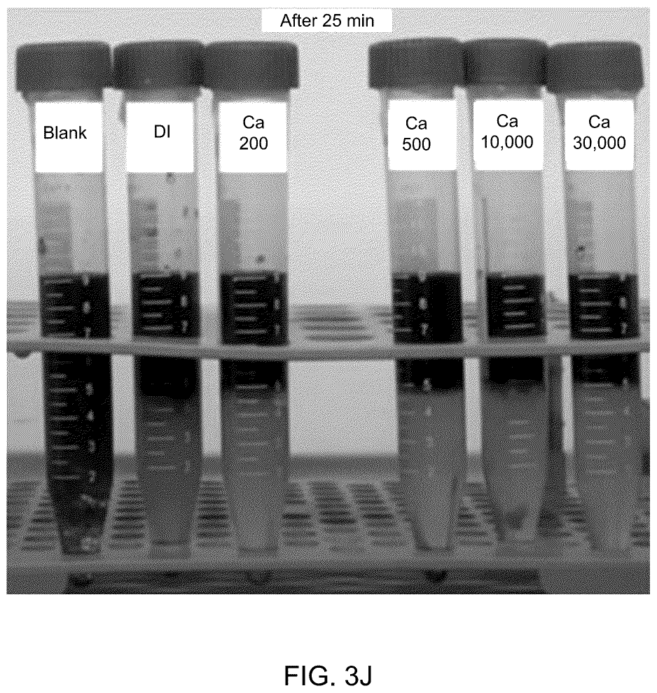

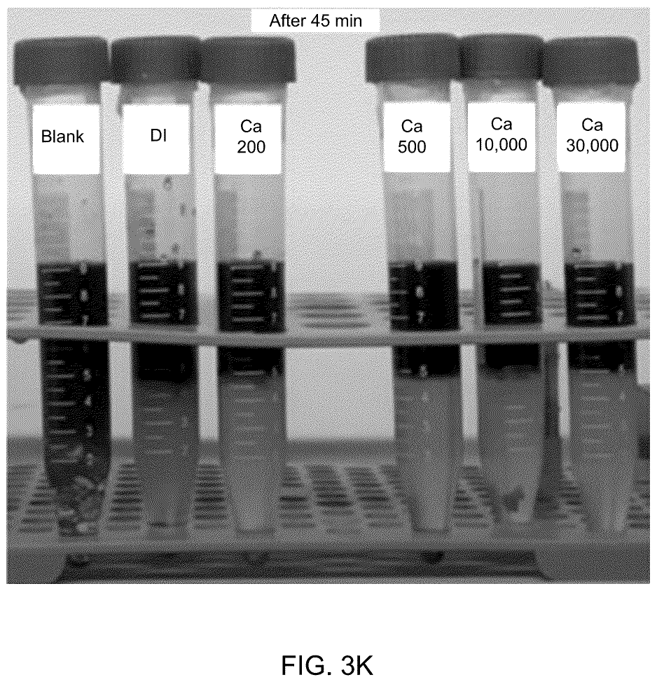

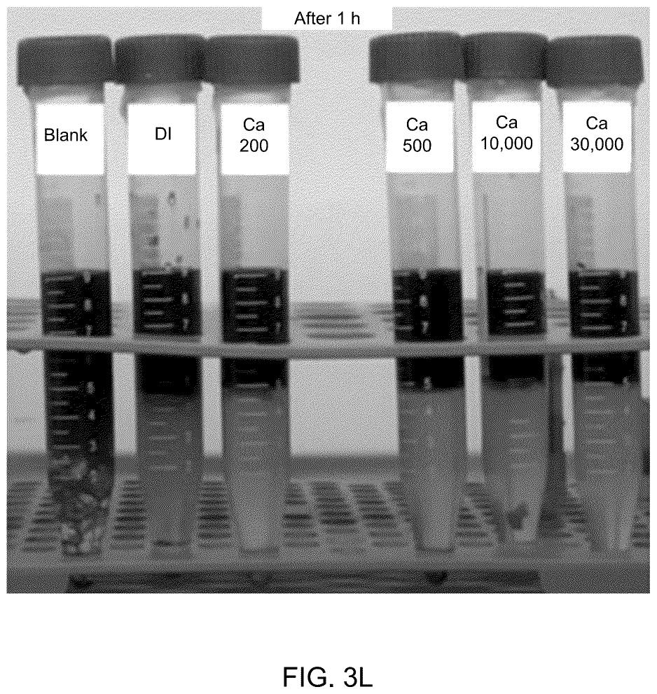

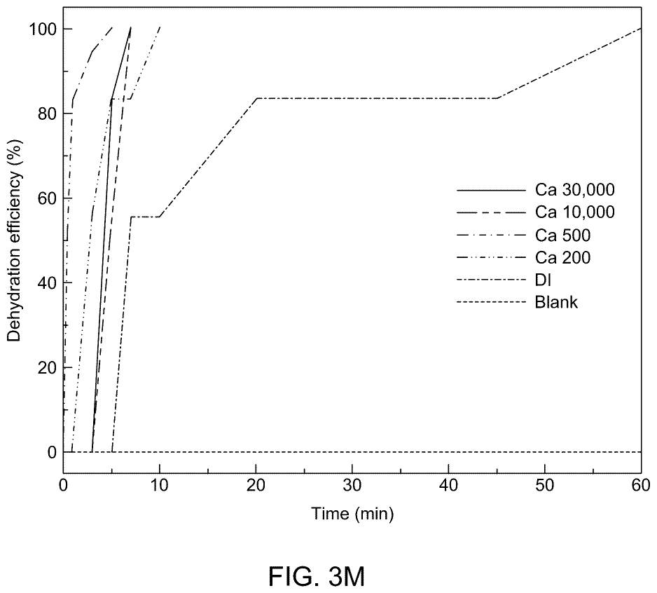

The effect of adding CaCl₂) for demulsifying crude oil emulsions was investigated by conducting two demulsification experiments, as shown in FIGS. 2A through 2Q and FIGS. 3A through 3M. As seen in FIGS. 2A through 2Q, the tubes were hand-shaken for two minutes to ensure the spreading of the demulsifier within the emulsion, followed by monitoring the phase separation at room temperature. A benchmark sample (blank), free of demulsifier and CaCl₂), was also prepared to demonstrate the stability of the prepared emulsions. The dehydration efficiency (DE %) was calculated according to equation (1):

$$DE \% = ( V / {V}_{0} ) \times 100 \qquad ( 1 )$$

where V represents the volume of water that is separated from the emulsion and V₀ denotes the initial volume of water. FIGS. 2A through 2Q represent the five emulsions at time zero, as it can be seen that water and oil are well mixed, and no separation can be observed. After 2 min, C500 and C10,000 samples displayed water separation (i.e., dehydration) of about 20%, while the remaining samples didn't show any separation. Furthermore, water separation of 75% and 90% was observed for C500 and C10,000 after 5 min, respectively. Moreover, full phase separation for C10,000 was achieved in 7 min, whereas the C500 sample reached full phase separation (i.e., full dehydration) after 12 min. The separation of sample C30,000 started after 7 min with 20% water separation and 100% full phase separation after 12 min. Although the DI sample (with demulsifier only) displayed some instability, there wasn't any clear water separation until 25 min later, with only 20% water separation. After 40 min, 80% water separation was observed for the DI sample, and complete dehydration after 4 hours. The blank sample remained stable during the whole time.

As seen in FIGS. 3A through 3M, C500 showed 50% water separation within less than a minute and reached 80% water separation after only 1 min. Full separation was achieved by the C500 sample at 3 min. All C200, C10,000, and C30,000 samples showed some separation at 3 min with around 50% water separation and full phase separation being achieved after 5 min. The DI sample started to separate after 5 min but with very turbid water. After 20 to 45 min, the DI sample reached 80% water separation and almost full phase separation after 1 hour. The presence of CaCl₂) significantly accelerated the demulsification process. Emulsions treated with CaCl₂) exhibited rapid phase separation, with dehydration efficiencies reaching 100% within 5 to 12 minutes at a concentration of 500 ppm (0.0125% wt. %). In comparison, emulsions treated with DI water alone showed slower and less efficient demulsification, taking 1 to 4 hours for complete separation.

### Example 3: Materials and Methods for ZnCl₂ Testing

The same materials and methods used are the same as above, except CaCl₂) is replaced with ZnCl₂. The ZnCl₂ was purchased from Sigma Aldrich and used as is. The incorporation of the ZnCl₂ solution into the water-in-oil emulsion to obtain the emulsion mixture was performed by two separate methods, either by (1) incorporating the ZnCl₂ within the water-in-oil emulsion by mixing the crude oil with a ZnCl₂ solution at different ZnCl₂ concentrations or (2) adding the ZnCl₂ solution as an external additive. The prepared emulsion mixtures were then placed in bottles. Each bottle prepared by the first method of ZnCl₂ incorporation (mixing ZnCl₂ solution in the crude oil) contains 4 mL of the lab-made water-in-oil emulsion (60 wt. % DI water or brine, 40 wt. % crude oil), 4 mL of 0.02 wt. % demulsifier dissolved in xylene, and ZnCl₂ at various concentrations. The concentrations of ZnCl₂ tested are 0 ppm ZnCl₂ solution (DI only), 200 ppm ZnCl₂, solution (0.02 wt. %) (Zn200), 500 ppm ZnCl₂ solution (0.05 wt. %) (Zn500), 10,000 ppm ZnCl₂ solution (1 wt. %) (Zn10,000), 30,000 ppm ZnCl₂ solution (3 wt. %) (Ca30,000). A blank was also prepared and bottled, which contains 4 mL of the lab-made water-in-oil emulsion and 4 mL demulsifier in xylene. Each bottle prepared by the second method of ZnCl₂ incorporation (adding ZnCl₂ as external additive) contains 3 mL of lab-made water-in-oil emulsion (60 wt. % DI water, 40 wt. % crude oil), 3 mL of 0.02 wt. % demulsifier dissolved in xylene, and 3 mL of brine with various ZnCl₂ concentrations. A blank was also prepared and bottled, which contains 3 mL of the lab-made water-in-oil emulsion, 3 mL of demulsifier in xylene, and 3 mL DI water (no ZnCl₂).

### Example 4: Demulsification Test of Prepared Emulsion Mixtures with ZnCl₂

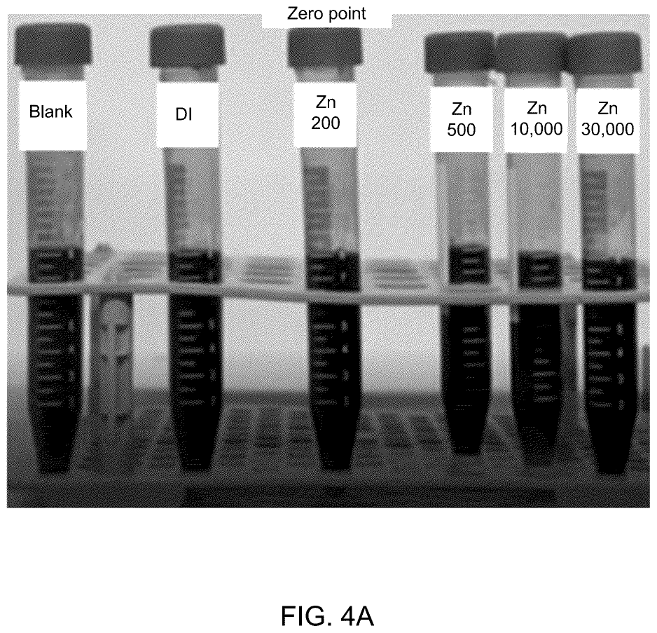

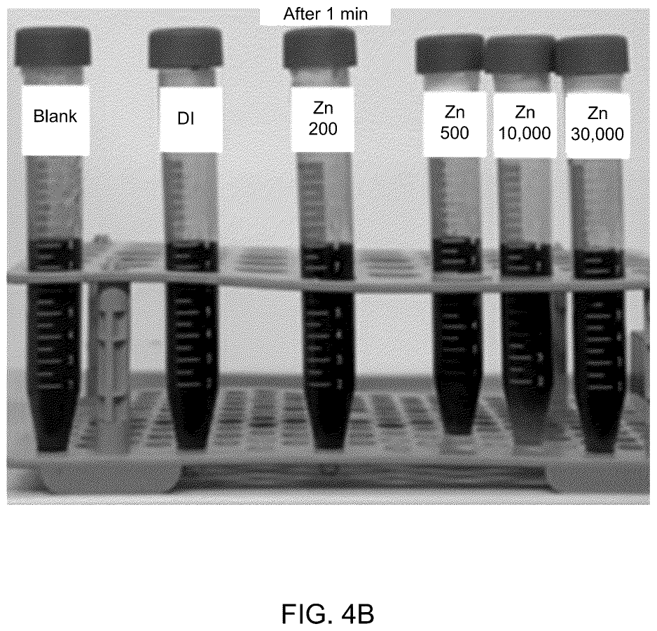

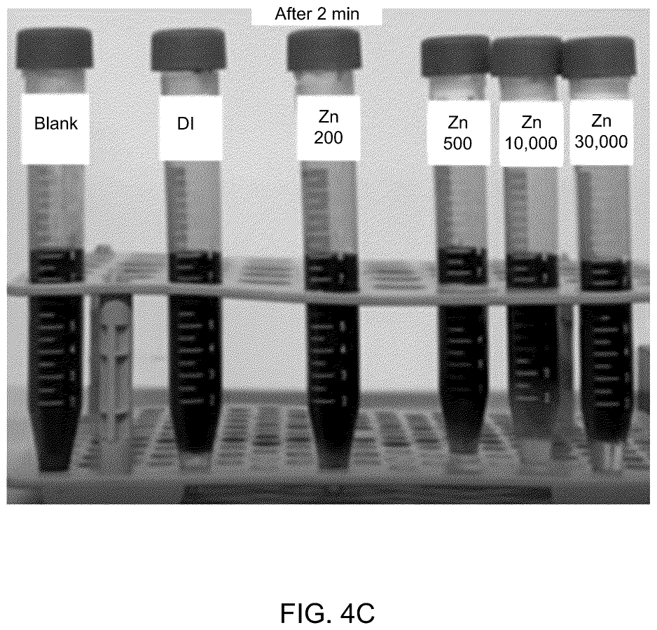

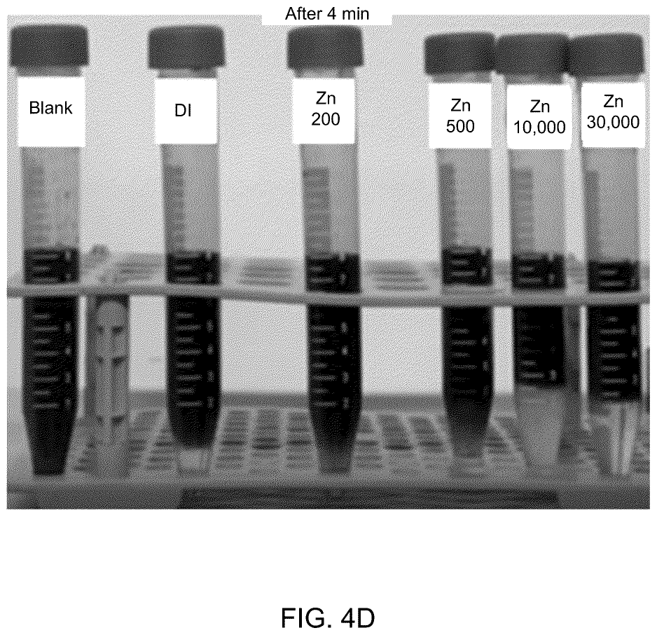

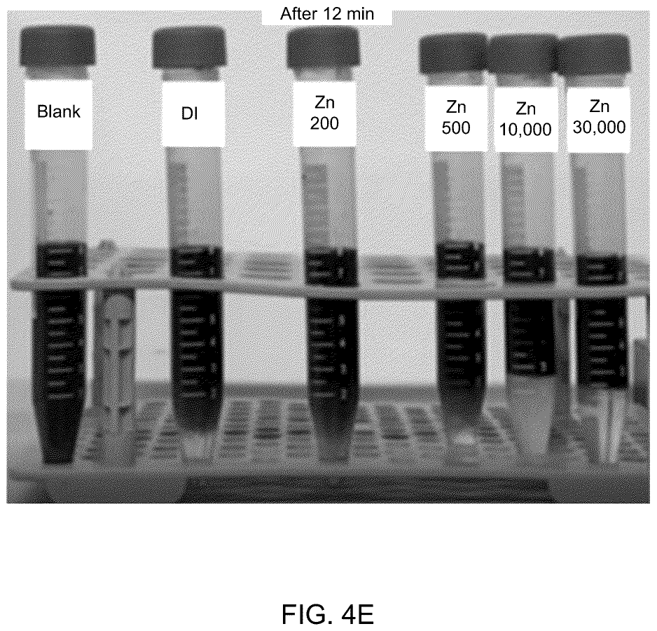

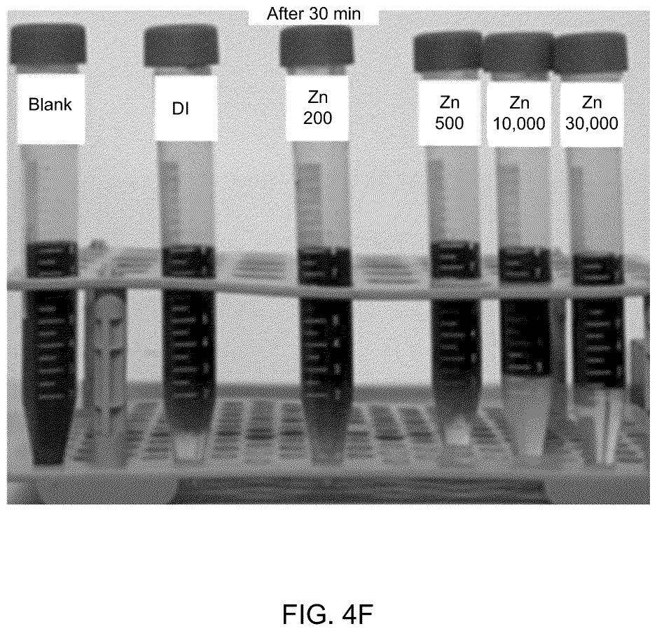

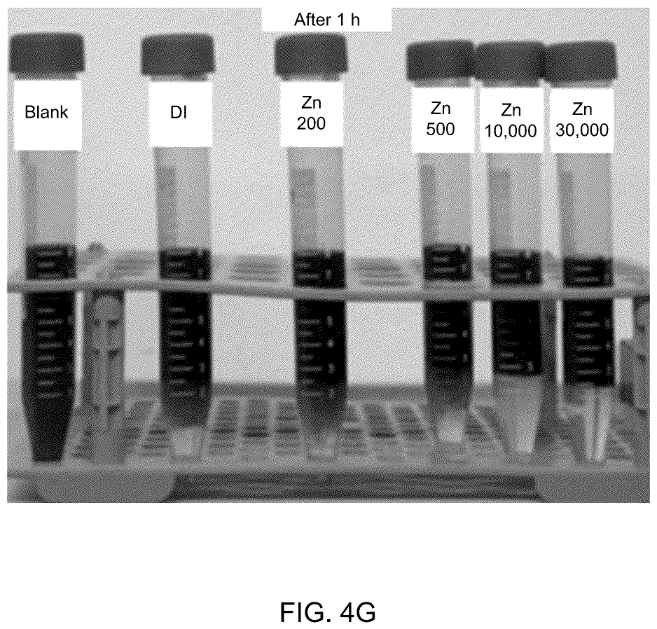

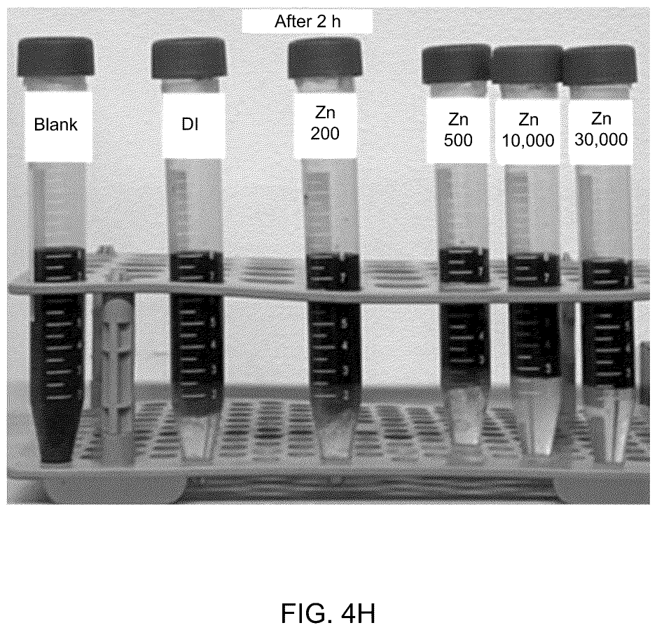

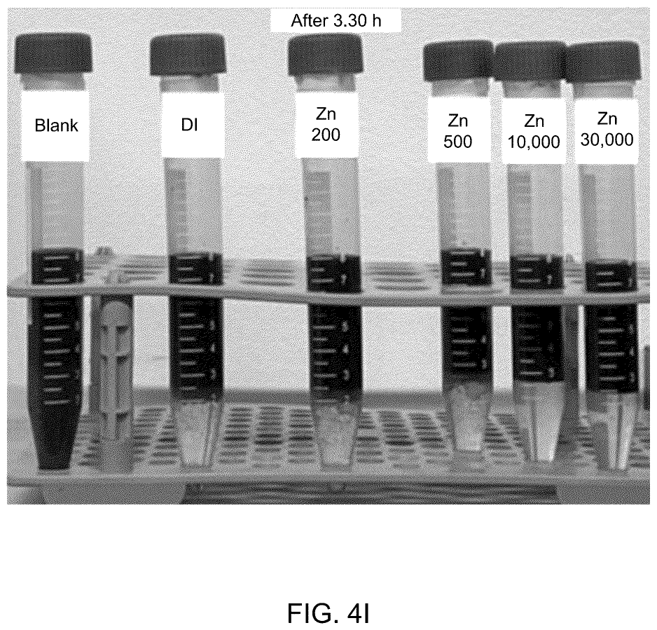

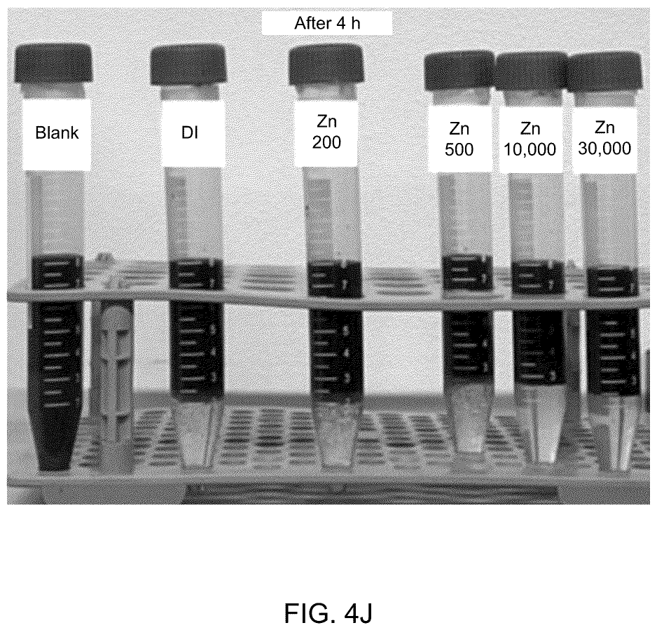

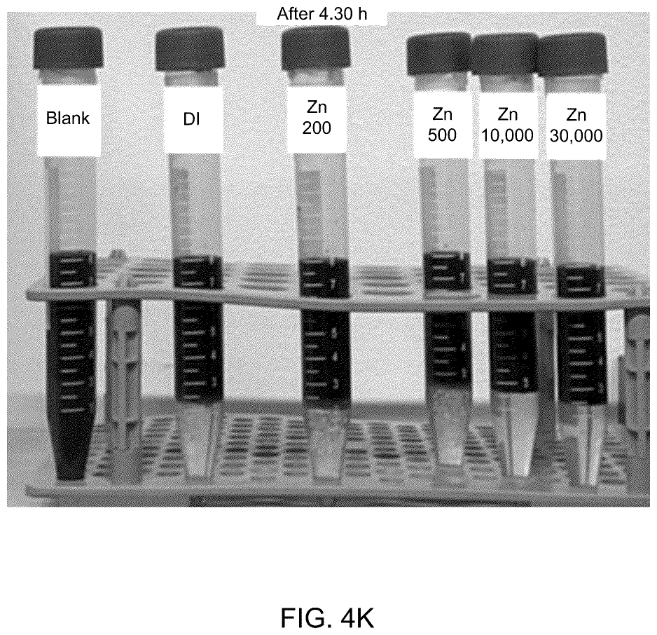

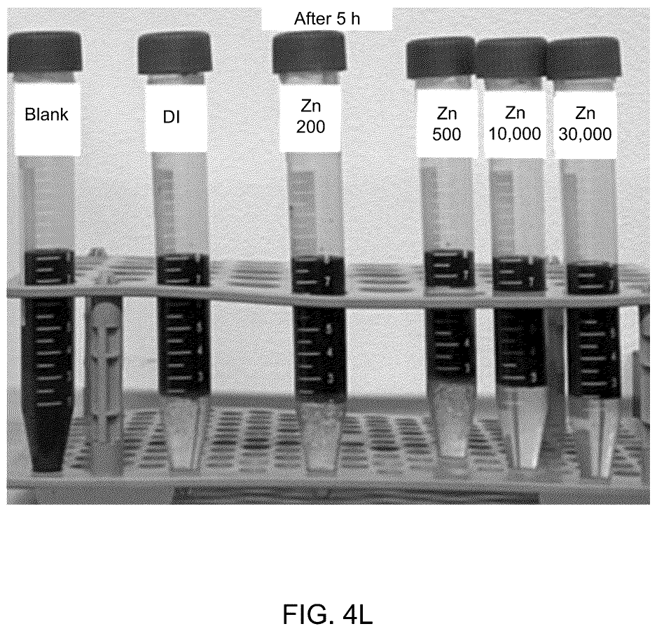

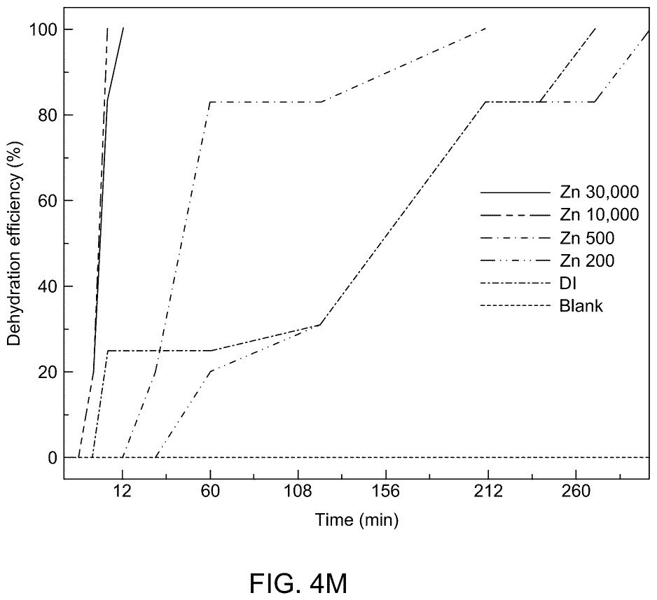

The effect of ZnCl₂ in demulsifying crude oil emulsions was investigated similarly to the CaCl₂) in Example 2. Four lab-made emulsions with different ZnCl₂ concentrations of 200, 500, 10,000, and 30,000 ppm were prepared along with a benchmark sample with DI only, as shown in FIGS. 4A through 4M. Full phase separation of the emulsion was achieved within 4 min only for the Zn10,000 sample, whereas Zn30,000 reached full phase separation after 12 min. Although a lower concentration of ZnCl₂ of 500 ppm took longer to separate, around 3 h and 30 min, it was faster than the DI-only emulsion which demulsified completely after an additional hour. Furthermore, it was observed that a concentration of 200 ppm of ZnCl₂ is not enough to accelerate the separation of the emulsion effectively. Adding ZnCl₂ improved the demulsification performance, albeit to a lesser extent than CaCl₂) at the same concentration of 500 ppm. However, emulsions treated with ZnCl₂ achieved complete separation within 4 minutes at a higher concentration of 10,000 ppm (0.25%). Lower concentrations of ZnCl₂ resulted in longer separation times, indicating the importance of an optimal dosage for effective demulsification.

The present disclosure describes the use of CaCl₂) and ZnCl₂ as demulsifiers for crude oil emulsions to achieve rapid and efficient demulsification. By improving the separation efficiency of water-in-oil emulsions, these demulsifiers can enhance processing, oil recovery, and overall operational efficiency.

Numerous modifications and variations of the present disclosure are possible in light of the above teachings. It is, therefore, to be understood that within the scope of the appended claims, the invention may be practiced otherwise than as specifically described herein.

1. A method of demulsifying a water-in-oil emulsion at room temperature, comprising:
mixing an organic demulsifier solution comprising an organic solvent and 200 ppm of a demulsifier based on a total mass of the organic demulsifier solution with the water-in-oil emulsion to obtain an emulsion mixture;
mixing an aqueous solution consisting of water and a chloride salt of a divalent zinc ion or a divalent calcium ion with the water-in-oil emulsion to obtain a final emulsion, wherein the water-in-oil emulsion comprises 60 wt. % or more of water, 40 wt. % or less of an Arabian crude oil, and 0.005 to 2.5 wt. % of a chloride salt of a divalent zinc ion or a divalent calcium ion based on the total weight of the final emulsion;
agitating the final emulsion to obtain an agitated emulsion; and
separating the agitated emulsion to form an oil phase and a water phase,
wherein the agitated emulsion achieves full phase separation to form the water phase and the oil phase in 7 minutes or less.

2. The method of claim 1, wherein the water-in-oil emulsion comprises 70 wt. % or more of water.

3. The method of claim 1, wherein the water-in-oil emulsion comprises 30 wt. % or less of the Arabian crude oil.

4. The method of claim 1, wherein the aqueous solution consists of water and 0.005 to 0.25 wt. % of the chloride salt of the divalent zinc ion or the divalent calcium ion.

5. The method of claim 1, wherein the aqueous solution consists of water and 0.0125 to 0.25 wt. % of the chloride salt of the divalent zinc ion or the divalent calcium ion.

6. The method of claim 1, wherein the aqueous solution consists of water and 0.0125 wt. % of the chloride salt of the divalent calcium ion.

7. The method of claim 1, wherein the aqueous solution consists of water and 0.25 wt. % of the chloride salt of the divalent zinc ion.

8. The method of claim 1, wherein the chloride salt of the divalent calcium ion is CaCl₂).

9. The method of claim 1, wherein the chloride salt of the divalent zinc ion is ZnCl₂.

10. The method of claim 1, wherein the Arabian crude oil has a density of 0.5 to 0.9 kg·m⁻³.

11. The method of claim 1, wherein the Arabian crude oil has a density of 0.8843 kg·m⁻³.

12. The method of claim 1, wherein the organic demulsifier solution comprises at least one organic solvent selected from the group consisting of xylene, acetone, acetonitrile, ethanol, formaldehyde, ether, ethyl acetate, hexane, and toluene.

13. The method of claim 1, wherein the Arabian crude oil has a viscosity of 10 to 20 mPa·s.

14. The method of claim 1, wherein the Arabian crude oil has a viscosity of 15.1 mPa·s.

15. The method of claim 1, wherein the Arabian crude oil comprises 30 to 35 wt. % of aromatics, 35 to 40 wt. % saturates, 10 to 15 wt. % of asphaltenes, and 15 to 20 wt. % of resins.

16. The method of claim 1, wherein the Arabian crude oil comprises 33.15 wt. % of aromatics, 38.44 wt. % saturates, 12.10 wt. % of asphaltenes, and 16.32 wt. % of resins.

17. The method of claim 1, wherein the final emulsion has a weight ratio of an amount of the emulsion mixture to an amount of the aqueous solution of 1:2 to 2:1.

18. The method of claim 1, wherein the final emulsion has a weight ratio of an amount of the emulsion mixture to an amount of the aqueous solution of 1:1.

19. The method of claim 1, wherein the agitated emulsion separates to form the water phase and the oil phase in less than 5 minutes.

20. The method of claim 1, wherein the agitated emulsion separates to form the water phase and the oil phase in less than 3 minutes.
